(19) United States
(12) Patent Application Publication
(10) Pub. No.: US 2002/0112076 A1
(43) Pub. Date: Aug. 15, 2002

(54) Internet protocol-based computer network service

(76) Inventors: Jose Alejandro Rueda, Winnipeg (CA); Andrew Glen Paryzek, Nepean (CA); Gwynn Kruger, Winnipeg (CA); Paxton James Smith, Selkirk (CA); Mark Joseph Komus, Winnipeg (CA); Mark Orthodoxou, Winnipeg (CA)

Correspondence Address: ADE & COMPANY, 1700-360 MAIN STREET, WINNIPEG, MB, R3C3Z3, CA

(21) Appl. No.: 09/774,007

(22) Filed: Jan. 31, 2001

Related U.S. Application Data
(60) Provisional application No. 60/179,144, filed on Jan. 31, 2000.

(51) Int. Cl. G06F 15/16

(52) U.S. Cl. 709/245; 709/206

(57) ABSTRACT

The system is an Internet Protocol-based computer network service that when installed, allows connected computers access Internet Protocol-based services if they are configured for any Internet Protocol-based network. This is different from a conventional Internet Protocol-based network in which connected computers must be configured specifically for that network to access Internet Protocol-based services or to have custom applications running on them to allow this access. These services include, but are not limited to, World-Wide-Web browsing, sending and/or receiving electronic mail, file transfer, and multimedia conferencing. The system supports any service that is Internet Protocol-based. The system is completely software-based. That is, it is a set of algorithms that are run on a computing platform. The platform that is executing the algorithms (the server) is a stand-alone system. No proprietary software is installed on the client.

This application claims priority under 35 U.S.C.119 from Provisional Application Serial No. 60/179,144 filed Jan. 31, 2000.

The application relates to an Internet Protocol-based computer network service that when installed, allows connected computers access Internet Protocol-based services if they are configured for any Internet Protocol-based network.

### THE FIELD OF THE INVENTION

In recent times, personal computer use has become extremely popular in many parts of the world. Originally, computers were large complex machines that required highly skilled operators to perform even the most mundane computing tasks. Early computers were reserved for very specific tasks typically dealing with military applications.

With the advent of the Integrated Circuit, and the drastic reduction in size of every computer component, it has been possible to create computers that could fit on a typical desk. The speed of handling data, the ease of use for formatting documents, and the archival capacity of computer storage devices have all played a part in the explosive growth of personal desktop computers. Particularly in the corporate environment, the applications to which computers were being used for brought about the need for connectivity. In order to send data for central processing or any other location, a connection had to be made.

Networks were designed as groups of computers that could share data with several other computers over some kind of medium, typically a wire. Large networks were built where communication could take place over many miles. Several projects in the United States eventually brought about the formation of the Internet. Several different computing platforms were able to inter-communicate using Internet Protocol (IP). Data would be divided into variable-length packets and delivered to an Internet Protocol Address using a novel method of routing these packets.

Several other protocols were developed (are under development) that used IP as a foundation. Electronic messaging was designed to allow people to exchange messages even if the intended target was not working on their computer: a server would keep the message until the recipient wished to read it. Message boards were developed as “newsgroups” where everyone connected to the Internet could post their ideas and read those of others. A protocol was developed for the reliable transfer of files. Recently, multimedia conferencing protocols have been developed to allow for voice, video, and data traffic to pass over networks with an IP foundation. The World-Wide-Web (WWW) is also IP-based, and is growing ever more popular with “online” shopping, information retrieval, and real-time Internet games becoming more popular each day.

With the quantity and quality of the services available from the Internet, people want to have access to these services wherever they go. Development into Internet access from cellular phones and automobile-based computers as recently taken place, and the list of Internet access points is ever growing. People want to take the Internet with them wherever they go.

The original inventors of the Internet and IP had never conceived of this system supporting such services or such a quantity of users. Their goal was to develop an Inter-network that worked. Thus, there is no support for the mobile user in IP. New standards have been developed in order to allow people to connect to the Internet from “anywhere”, but there has been no simple universal solution.

One problem is that the Internet is divided into several smaller subnets that contain a range of fixed IP addresses and other configured IP parameters. A particular set of parameters may work on a subnet, but if those parameters are to be used on another subnet, the Internet cannot route data back to that particular computer, nor can that computer even access the Internet. To move a computer from one subnet to another requires that computer reconfigure its IP parameters. To the average computer user this is a complex task.

However, if a person brings their portable computer along with them on a trip, it is reasonable to assume that they would wish to access Internet services (electronic mail or WWW browsing) from their hotel room, hospitality office, or even the airport. Connecting to the Internet at every one of these locations would require some IP reconfiguration at the least. A hotel or airport that could provide Internet access without reconfiguration would benefit the traveler for this kind of convenience.

### DESCRIPTION OF RELATED ART

### Related U.S. Patents

TABLE 1
Network Address Translation

| | | |
|---|---|---|
| 6,058,431 | 05/02/2000 | System and method for network address |
| | | translation as an external service in the access |
| | | server of a service provider |
| 6,178,455 | 01/23/2001 | Router which dynamically requests a set of |
| | | logical network addresses and assigns addresses |
| | | in the set to hosts connected to the router |
| 6,047,325 | 04/04/2000 | Network device for supporting construction of |
| | | virtual local area networks on arbitrary local |
| | | and wide area computer networks |
| 6,006272 | 12/21/1999 | Method for network address translation |
| 5,793,763 | 08/11/1998 | Security system for network address translation |
| | | systems |
| 5,227,778 | 07/13/1993 | Service name to network address translation in |
| | | communications network |

Masquerading

| | | |
|---|---|---|
| 5,812,126 | 09/22/1998 | Method and apparatus for masquerading online |
| 5,717,756 | 02/10/1998 | System and method for providing masquerade |
| | | protection in a computer network using |
| | | hardware and timestamp-specific single use |
| | | keys |
| 4,930,159 | 05/29/1990 | Netbios name authentication |

DHCP (Dynamic Host Configuration Protocol)

| | | |
|---|---|---|
| 5,884,024 | 03/16/1999 | Secure DHCP server |
| 6,009,103 | 12/28/1999 | Method and system for automatic allocation of |
| | | resources in a network |
| 5,944,029 | 07/13/1999 | Method for using DHCP and marking to |
| | | override learned IP addresses in a network |
| 6,101,182 | 08/08/2000 | Universal access multimedia data network |
| 6,058,421 | 05/02/2000 | Method and system for addressing network host |
| | | interfaces from a cable modem using DHCP |
| 5,790,548 | 08/04/1998 | Universal access multimedia data network |
| 6,073,178 | 06/06/2000 | Method and apparatus for assignment of IP |
| | | addresses |
| 6,170,061 | 01/02/2001 | Method and system for secure cable modem |
| | | registration |
| 6,061,739 | 05/09/2000 | Network address assignment using physical |
| | | address resolution protocols |
| 6,023,464 | 02/08/2000 | Auto-provisioning of user equipment |
| 5,812,819 | 09/22/1998 | Remote access apparatus and method which |
| | | allow dynamic internet protocol (IP) address |
| | | management |

Host Configuration

| | | |
|---|---|---|
| 6,178,455 | 01/23/2001 | Router which dynamically requests a set of |
| | | logical network addresses and assigns addresses |
| | | in the set to hosts connected to the router |
| 6,101,499 | 08/08/2000 | Method and computer program product for |
| | | automatically generating an internet protocol |
| | | (IP) address |
| 6,073,178 | 06/06/2000 | Method and apparatus for assignment of IP |
| | | addresses |
| 5,922,049 | 07/13/1999 | Method for using DHCP and marking to |
| | | override learned IP addresses in a network |
| 5,835,727 | 11/10/1998 | Method and apparatus for controlling access to |
| | | services within a computer network |

Internet Access

| | | |
|---|---|---|
| 6,012,088 | 01/04/2000 | Automatic configuration for internet access |
| | | device |
| 5,774,869 | 06/30/1998 | Method for providing sponsor paid internet |
| | | access and simultaneous sponsor promotion |
| 5,925,103 | 07/20/1999 | Internet access device |
| 6,085,177 | 07/04/2000 | Systems for accessing the internet and geo- |
| | | defined data and associated methods |
| 5,764,739 | 06/09/1998 | System and method for providing a remote user |
| | | with a virtual presence to an office |
| 6,128,298 | 10/03/2000 | Internet protocol filter |
| 6,044,376 | 03/28/2000 | Content stream analysis |
| 6,026,441 | 02/15/2000 | Method for establishing communication on the |
| | | internet with a client having a dynamically |
| | | assigned IP address |
| 5,889,958 | 03/30/1999 | Network access control system and process |

### DHCP

Dynamic Host Configuration Protocol (DHCP - RFC 2131) provides configuration parameters to Internet hosts using a client-server model. Diskless nodes to discover IP addresses, gateway servers, subnet masks, and operating system files use it. After obtaining parameters via DHCP from a DHCP-enabled server, a DHCP client should be able to exchange packets with any other host in the Internet.

DHCP is designed to temporarily assign network users IP addresses. It is required to be supported at both the client and the server. DHCP could be adapted to the mobile computing scenario. If each visiting client had DHCP software, a DHCP server present at a hospitality center could easily be used to configure the visiting clients. However, DHCP isnt intended for typical mobile users, who do not use DHCP but have a pre-existing configuration and would require manual reconfiguration anyway.

It is unreasonable to assume that all or even most corporate subnets use DHCP. Only in such a scenario would DHCP be a viable mobile computing solution.

DHCP can easily be supported on The system. All that is required is the installation of server software that supports DHCP. A valid pool of IP addresses must be configured for assignment on the System server. Once assigned an IP address and valid network parameters, the client computer will act like any other visiting client.

### Mobile IP

Mobile IP (RFC 2002) establishes the mechanism that enables a mobile host to maintain and use the same IP address as it changes its point of attachment to the Internet. Each mobile node is always identified by its home address, regardless of its current point of attachment to the Internet. While situated away from its home network, a mobile node is also associated with a ‘care-of’ address, which provides information about its current point of attachment to the Internet. The protocol provides for registering the care-of address with a home agent. The home agent sends datagrams destined for the mobile node through an IP tunnel to the care-of address. After arriving at the end of the tunnel, each datagram is then de-tunneled and delivered to the mobile node.

The Mobile IP protocol does not define how a mobile node can use mobility services when the mobile node's home network is a private network. This procedure is specified in RFC2356.

Unlike DHCP, Mobile IP is meant to provide mobility to computer users. However, it places many requirements on the client machines, the home network, and the foreign network. All three components must be configured for the use of Mobile IP. Although Mobile IP is quickly becoming a common technology, it is at this point still unreasonable to assume that all or even most corporate subnets use Mobile IP.

The system also supports the Mobile IP protocol. Mobile IP essentially only specifies a registration method with the mobile client's home agent. Therefore, at the System server, a custom Mobile IP agent would periodically poll the System client network with Agent Advertisement messages. If a mobile node is present on the network, then the mobile node would use the IP address contained in the Agent Advertisement message as its foreign care-of IP address. The mobile node would then try to register with its home agent using a Registration Request message. At this point, the System server's Mobile IP agent would respond with a spoofed Registration Reply, which would fool the visiting client into thinking, that registration with the home agent was successful. The connection procedure with any destination server through the System server would then continue like for any other visiting client on the System client network.

### PRODUCTS

Elastic Networks, a Georgia-based independent unit of Nortel Networks, was established to deliver powerfully simple Ethernet-based communications over any phone line. The group's mission is to create solutions that stretch corporate LANs out of the office, following the trend towards increasingly distributed corporate networks. Their product, InterProxy, acts like an IP translator, allowing users to access the Internet without the requirement to install any software or reconfigure any settings. When a user plugs into an Ethernet network using an InterProxy server, the server detects the laptops foreign IP address. InterProxy then dynamically sets up a session to translate traffic into a valid IP address between the user and other network resources such as the Internet or local printers.

The Interproxy server includes two 10 Mbps or 100 Mbps Ethernet cards and typically sits behind a router connected to the Internet or a WAN connection in a branch office. Currently, a single InterProxy server supports up to 400 concurrent users, and the character-based management interface must be accessed through a TELNET session through the server's serial port.

The InterProxy product is functionally closer to the System than IPORT. The key differences between the System and InterProxy is that the System is a software solution and is not hardware-specific like InterProxy.

CAIS Software Solutions (IPort) is a San Diego based company who's corporate mission is to increase the installed base, customer use, and public and industry awareness for public information terminals and public Internet ports. Their product, IPORT, links Ethernet data ports in hotel guestrooms and other locations to the Internet over a T1 or other high-speed line, bypassing the hotel's PBX. A typical installation in a medium-to-large size hotel.

IPORT acts as a gatekeeper granting access to users based on a variety of payment options including prepayment for services, free access, credit card payment for use, payments charged to the hotel room bill, and other payment methods. The IPORT server manages a single high-speed Internet connection to the property. The user in a room connects to an IPORT jack which is in turn connected to the IPORT network in the property. The IPORT server in this example is installed in a hotel and can post a charge for IPORT use to the Property Management System (PMS). The IPORT Server gates the user out to the Internet after authorizing payment.

IPORT runs on Microsoft's Windows NT Server 4.0 Operation System and is based on the Microsoft BackOffice platform, using SQL server based billing. The IPORT server also runs Microsoft Proxy Server 2.0 and Windows NT Routing and Remote Access Server.

IPORT supports any computer so long as it has an Ethernet NIC and uses the TCP/IP protocol stack. Wireless LAN cards are also optionally supported by IPORT. The computer can be running a Windows or Macintosh operating system, it can be a UNIX laptop, or it can even by a Windows CE portable computer. IPORT supports several connection features for those users who satisfy the computing platform criteria. First, service is provided for those guests who are configured for the use of a proxy server using network address translation, ARP proxies, routing, and DNS and spoofing techniques. If a user is not configured for the use of a proxy server, IPORT enables public Internet port connections through the use of an IPORT client program, which automatically performs system reconfiguration and provides for system restoration after use. IPORT provides web browsing, e-mail, Telnet and FTP, network printing meeting management services to the visiting clients. IPORT also supports the connectivity of computers which are configured to obtain TCP/IP configuration information from a DHCP server and supports the Mobile IP standard. If the visiting user has VPN software installed on their laptop, IPORT provides VPN connectivity for most VPN applications on the market today.

IPORT supports web-based management. Hotel staff can access “Quick Look” reports immediately from anywhere on the Internet. Viewable information includes transaction logs, active ports, revenue-to-date and usage information.

Using Microsoft Site Server, IPORT provides a location-specific web page which the visiting client is presented with whenever he/she begins a session. In addition, if connection fails to the IPORT server, diagnostic information is presented to the user.

The System was originally intended for the corporate business user visiting a medium-to-large sized hotel. For this market segment, the System competes well with IPORT. The main difference between the System and IPORT is that the System supports non-proxy requests without the installation of special client software. IPORT requires client software to reconfigure the client's computer. This is due to the fact that IPORT uses a 3rd party proxy, Microsoft Proxy 2.0.

### Network Management Solutions

Many network management approaches have been specified or implemented recently which could be used to replace or compliment SNMP for the management of the System. Two such approaches shall briefly be introduced here: Windows Management Instrumentation (WMI), and the Systems Management Server (SMS) Version 2.0.

Windows Management Instrumentation (WMI) technology is an implementation of the Desktop Management Task Force's (DMTF) Web-Based Enterprise Management (WBEM) initiative for Microsoft Windows platforms that extends the DMTF Common Interface Model (CIM) to represent management objects in Windows management environments. WMI actually is a group of extensions to the Windows Driver Model (WDM) used to publish information, configure device settings and supply event notification from device and network drivers. WMI can be accessed directly through a web browser using HTML. WMI can be made to support SNMP through software components called SNMP Providers. WMI SNMP Providers convert the SNMP schema to the CIM schema. For more on WMI technology refer to [53] and [54]. Competitive products such as the ATCOM/INFO's IPORT provide web-based management tools for network administration.

The Systems Management Server Version 2.0 is a highly scaleable, WAN-aware product, built specifically to manage change and configuration in Windows-based desktops and servers. It is designed to be used either as a standalone system for Windows or as a suite of specialist services under the control of an enterprise management platform. It provides the following features:

Discovering system configurations.

Maintaining hardware and software inventory.

Installing and maintaining operating systems, drivers and application software.

Metering software use.

Performing systems and network troubleshooting and diagnostic tests.

Server health monitoring.

SMS Version 2.0 supports both WMI and MMC. For more on SMS Version 2.0 refer to [55]. SMS Version 2.0 adds the ability to remotely install software over SNMP. However, this solution does not make use of an open-standard interface. Used in conjunction with an enterprise platform such as HP OpenView, however, powerful management functionality could be offered for the System.

The discussion in this section has not considered the requirement for a local management system (i.e. access to information about the System's performance and status from inside the hotel).

### OBJECT AND SUMMARY OF THE INVENTION

The System is a network service implemented in software that allows a network (the client-side network) to have access to another network (the server-side or Internet-side network) using supported IP-based protocols. The individual clients on this network are only required to have the basic TCP/IP configuration without any special hardware and/or software to support the System services.

The important features of the system, as explained in more detail hereinafter, which may define patentable aspects are as follows

1. A collection of algorithms performed by a computing device that allows IP service access to any connected device with an IP configuration and applications supporting those services. These include the following aspects:

The algorithms support client devices that are configured to access IP services from their “home” location.

The algorithms act to cause the computing device to respond to all ARP requests with its own client-side hardware address.

The algorithms act to cause the computing device to forward DNS requests to a DNS server. Responds to the client with the System client-side IP if the name is non-resolvable.

The algorithms act to cause the computing device to read all IP packets on the client-side even if not addressed to the System server.

The algorithms act to cause the computing device to transparently proxy/forward all IP protocols, including FTP, NNTP, HTTP, POP3, SMTP, Telnet, Microsoft NetMeeting 2.1, and non-proxied services to the service portfolio.

2. The algorithms should provide a system to handle duplicate IP addresses.

3. The algorithms should provide a system to handle Security.

4. The algorithms should provide a system to handle Scalability and deployment phasing model.

5. The algorithms should provide a system to handle Redundancy.

6. The algorithms should provide a system to handle a Splash page or home web page insert.

7. The algorithms should provide a system to handle Billing.

8. The algorithms should provide a system to handle Network Printing.

9. The algorithms should provide a system to handle Network Management.

10. The algorithms should provide a system to handle Direct Internet access.

11. The algorithms should provide a system to handle IP Forwarding with IP Address Pool.

12. The algorithms should provide a system to provide an Alternate System Solution with Multiple Network Adapters.

13. The algorithms should provide a system to handle The characterization of the performance of the current implementation of the System: Logical operation, IP Throughput, Capacity; and Reliability.

14. The algorithms should provide Implementations on Windows NT and Linux.

The prototype for this service has been implemented for Windows NT4 Server edition as a combination of an intermediate NDIS driver (the System driver) and a user-level application (the System application). The System driver prototype has been designed specifically for a client-side network based on IEEE 802.3 (Ethernet), though this could be expanded to accommodate different IP-supporting networks such as modem dial-up. The server-side network can be any type of network as long as a TCP/IP stack can be set up for the appropriate server-side network adapter (i.e. Ethernet, modem, ADSL).

An example of where this service could be applicable is in a hotel environment where travelers would be able to have high-speed Internet access from within their suites with their computers that have been configured for their individual corporate LANs or home use. This service also includes support for billing and advertising. The hotel would provide Ethernet and/or phone drops in the appropriate suites that would be connected to a local System server. This server would also have a connection to an ISP in whatever manner was desired (leased line, cable modem, or modem dial-up).

With the growing popularity of communication over the Internet, more and more business transactions are initiated, negotiated and closed with no concern for geography. Regardless, travel still remains an intrinsic part of the corporate landscape. Out of the necessity for travel arises the need for a service which allows a mobile corporate computer user to retain all of the technology available on the home network without sacrificing convenience. The System can provide a configuration-free transparent service for mobile computer users equipped with IEEE 802.3 (Ethernet) Network Interface Controllers (NICS).

The System supports configuration-free access to WWW and other services for mobile users. The System has been developed using an architecture which supports an evolution path towards a full service offering.

Mobile users of the System require secure access to all TCP/IP applications which they normally use on their home networks. In addition, the proprietors of hospitality centers require that administration costs and maintenance be minimized, billing capabilities be available, and remote management be supported. Development is feasible to satisfy all of these requirements. Furthermore, mechanisms to avoid errors caused by exceptional circumstances, such as the arrival of two mobile clients with the same IP address at a hotel, can be developed on the System.

Services which are exactly or nearly functionally equivalent to the System, may be developed on several different architectures. A configuration-free service can be provided without the requirement for a gateway server to run a peer proxy program. Configuration-free access can also be provided using one network adapter per client at the intelligent server or even using a server which operates at a layer no higher than Layer 3, but rather just forwards IP packets. Development of this service using transparent proxies, using an embedded architecture, in hardware, and using the Linux operating system are also possible.

Finally, the System could provide a unique alternative to existing competitive products and technologies. More specifically, the service offered by the System complements three existing technologies for mobile access to computing resources: DHCP, Mobile IP and VPN. While providing a service quite different from all three of these technologies, the System also can be made to support users who traditionally have used such solutions for mobile computing. The System also could play a unique role in the medium-to-large hospitality center market. It could be made to offer transparent service to mobile users not configured to use a proxy server, without requiring proprietary software to be installed.

The work includes providing a specification for the connection of the System service to the hospitality center's administration network for the purpose of integrated local management and billing. Other considerations include an architecture to provide configuration-free connectivity to small hospitality centers or stand-alone kiosks, and the development of an architecture to support mobile users equipped with dial-up modems or cable modems. Also, the impact of and specific requirements for vendor-specific implementations of VPN is considered and the capacity and reliability of the System service has been thoroughly characterized.

An additional capability is the development of an adapter capable of supporting Ethernet in and Ethernet out which can be programmed to perform some simple manipulation of the Ethernet frames. Such an adapter also requires to have a serial port for configuration and monitoring.

### BRIEF DESCRIPTION OF THE DRAWINGS

FIG. 1 is a schematic illustration of the System mainline where a configuration file is read and if successful, services are started.

FIG. 2 is a schematic illustration of by which the System Retrieves the destination address from the client table using source IP and port number.

FIG. 3 is a schematic illustration of by which the System Uses Windows sockets to connect to a particular IP address and port.

FIG. 4 is a schematic illustration of by which the System Reads data packet from the source socket and direct it to the destination socket.

FIG. 5 is a schematic illustration of by which the System Checks for network traffic on the client-side and server-side and passes these messages to the call proxyMessage.

FIG. 6 is a schematic illustration of by which the System Listens for activity on the appropriate socket and determines the direction of the data, calling proxyMessage.

FIG. 7 is a schematic illustration of by which the System Initialize a socket on the given client and server ports and begin a new thread (handler function) to handle activity on that socket.

FIG. 8 is a schematic illustration of by which the System Handles any ARP requests by waiting for an ARP packet, responding with the System client-side IP address, and inserting the client into the route Table.

FIG. 9 is a schematic illustration of by which the System Processes a DNS query. If it is a local name, a response is made that delivers the System client-side IP address. If it is not, the entry is added to the DNSTable and the request forwarded to the DNS server.

FIG. 10 is a schematic illustration of by which the System Forwards a response from the DNS server to the System client. If the DNS server does not respond with a success, the System responds with a default response: its client-side IP address.

FIG. 11 is a schematic illustration of by which the System Initialize client-side and server-side sockets listening for DNS traffic. When a DNS packet arrives on the client-side, call RnetDnsHandleRqst. Packets arriving on the server-side are passed to RnetDnsRtnResp.

FIG. 12 is a schematic illustration of by which the System For each packet that arrives to the driver, creates a UDP packet with destination information and send to transport layer on the System port (60). Add client information to DestAddrPool if UDP packet or if a handshaking TCP packet. Delete DestAddrPool entry if TCP FIN flag is set.

FIG. 13 is a schematic illustration of by which the System Sends packets to the System clients. Changes destination IP and MAC addresses according to DestAddrPool and recalculates checksums before sending the packet to the client.

FIG. 14 is a schematic illustration of the System Architecture to solve the duplicate IP address scenario.

FIG. 15 is a schematic illustration of the System Architecture to solve the broadcast domain problem.

FIG. 16 is a schematic illustration of the System Invalid solution to the broadcast domain problem using a router.

FIG. 17 is a schematic illustration of the System Invalid solution to the broadcast domain problem using VLANs

FIG. 18 is a schematic illustration of the System Solution to the broadcast domain problem using an Ethernet switch with broadcast filtering.

FIG. 19 is a schematic illustration of the System Solution to the broadcast domain problem using an Ethernet adapter with broadcast filtering.

FIG. 20 is a schematic illustration of the Deployment of the System service in a 200-room hotel—Phase 1.

FIG. 21 is a schematic illustration of the Deployment of the System service in a 200-room hotel—Phase 2.

FIG. 22 is a schematic illustration of the Load balancing and redundancy architecture of the System.

FIG. 23 is a schematic illustration of the Network printing in the System client network.

FIG. 24 is a schematic illustration of the Fictional Inc. System SNMP management information base (MIB).

FIG. 25 is a schematic illustration of the System Method for direct Internet access.

FIG. 26 is a schematic illustration of the Scalability of System direct Internet access approach.

FIG. 27 is a schematic illustration of an Alternate System solution—IP IP forwarding with IP address pool.

FIG. 28 is a schematic illustration of the Scalability of IP forwarding with IP address pool solution.

FIG. 29 is a schematic illustration of an Alternate System solution—multiple network adapters.

FIG. 30 is a schematic illustration of the System client side perceived connection.

FIG. 31 is a schematic illustration of the System in the Windows NT protocol stack.

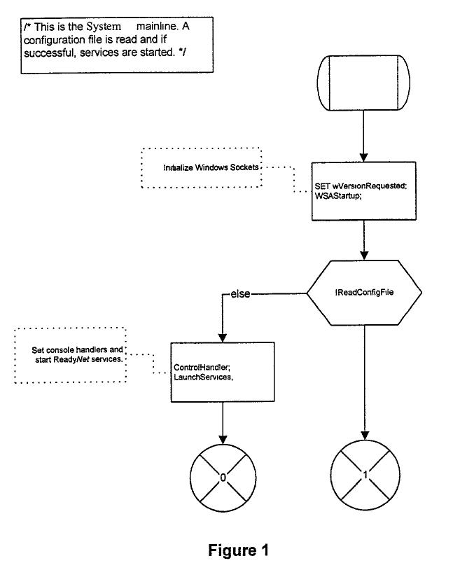

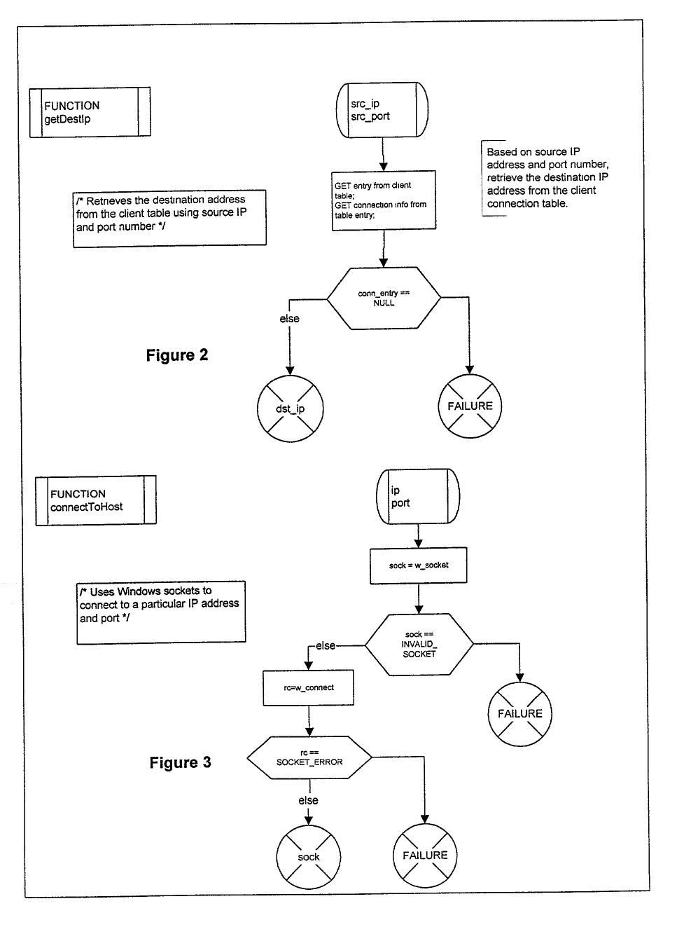

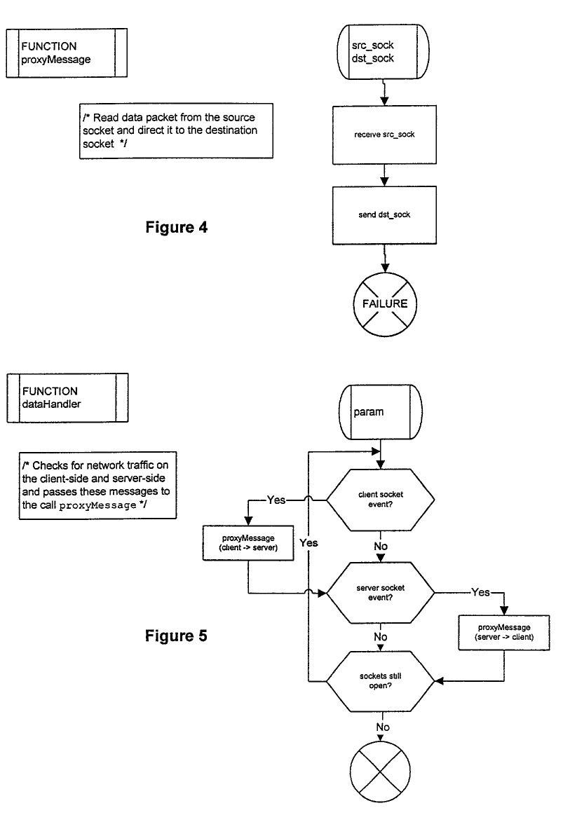

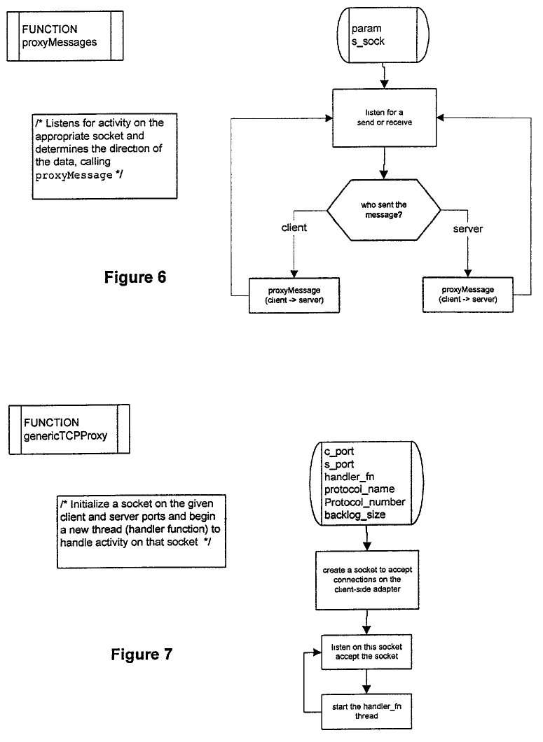

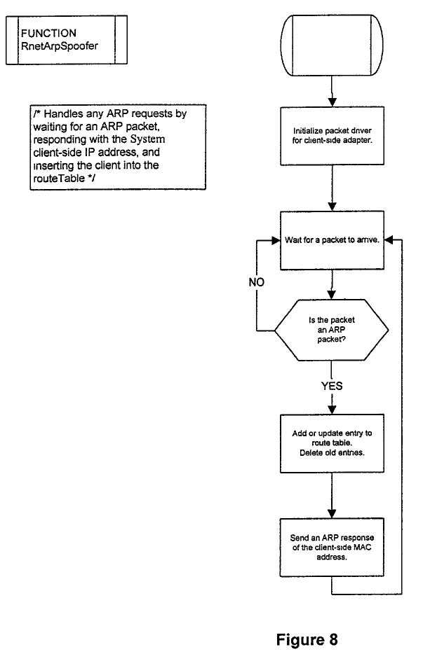

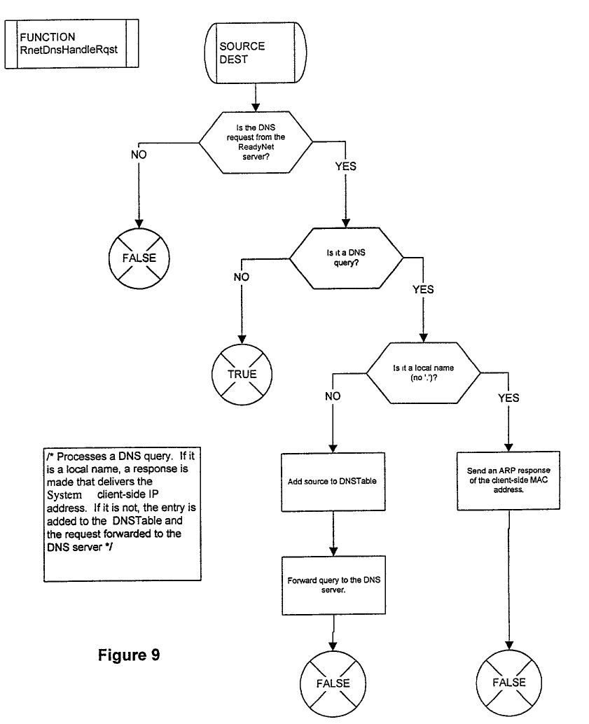

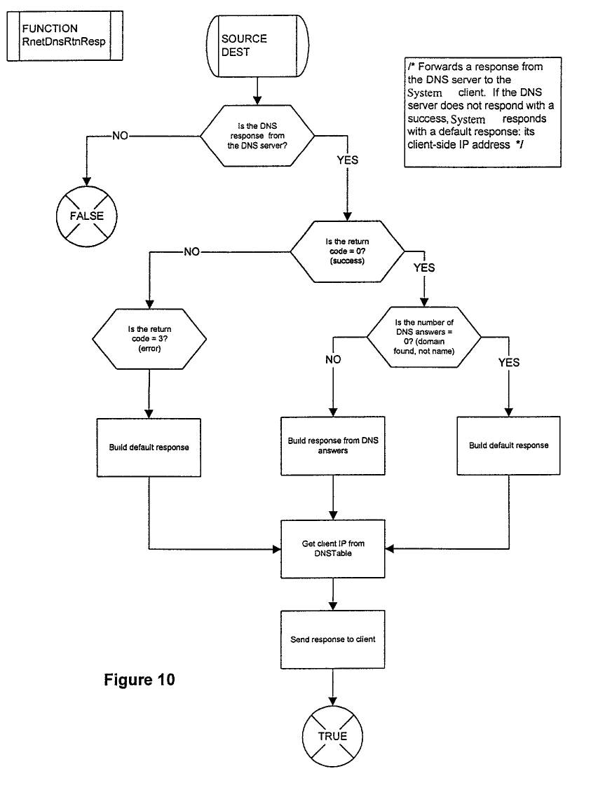

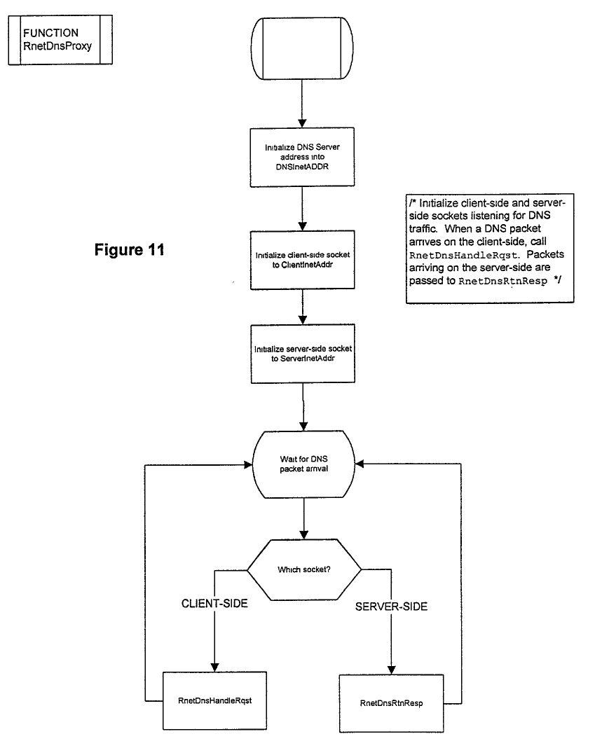

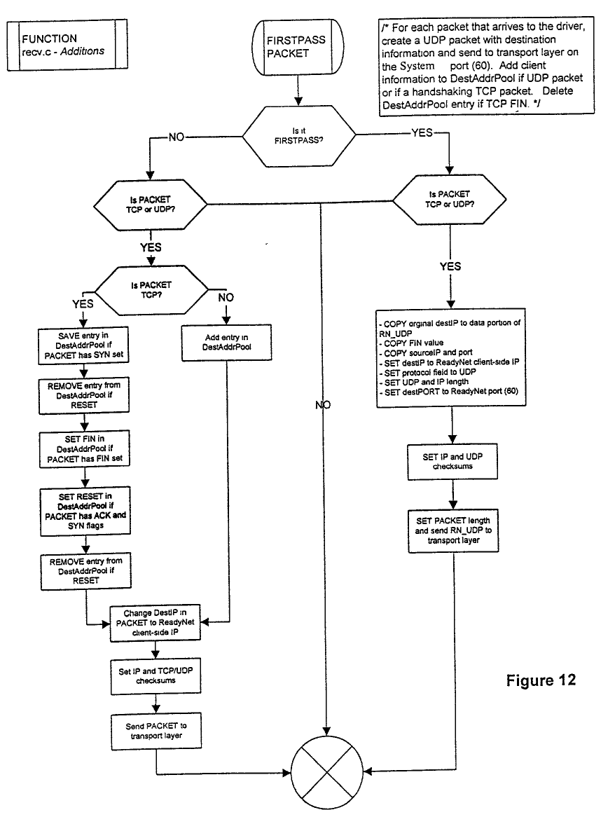

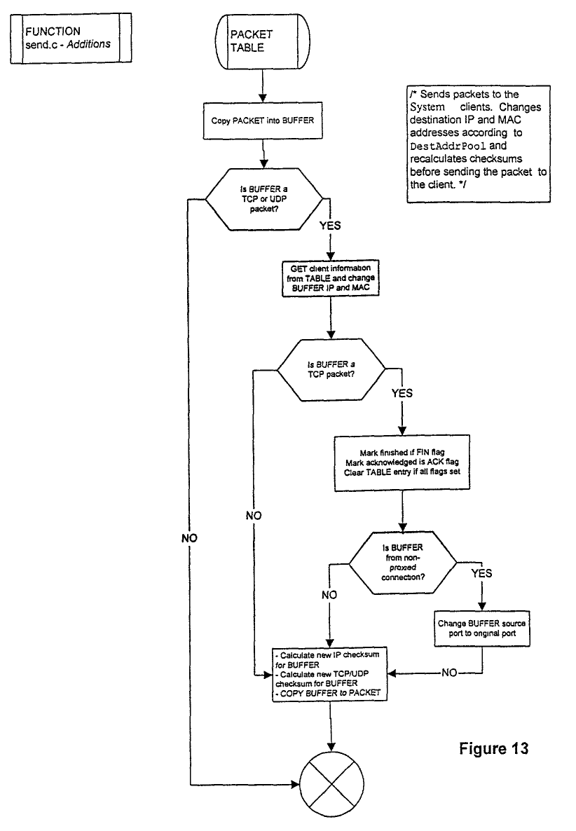

### BRIEF DESCRIPTION OF THE TABLES

Table 1 is the System SNMP Extension Agent.

Table 2 is the System SNMP Extension Agent trap.

Table 3 is the Static routing table using an IP address pool.

### DETAILED DESCRIPTION

### SYSTEM OVERVIEW

The System performs two main tasks to provide its configuration-free service. The first is to emulate any LAN that a client wishes to communicate on. The second is to transparently proxy any communication that a client initiates. In this manner, any services requested by a client will work as if it was on the LAN that it was actually configured for. It could find its specified gateway, its specified proxy server, the appropriate DNS servers, and any public addresses that it wished to communicate with.

### ARP Processing

The System detects any ARP requests that are generated on the client-side network. These would be present as the clients attempt to discover the physical address of the network adapters bound to a particular IP address. Common ARP requests would be for a client's specified gateway for accessing IP addresses that are not on their subnet. The System responds to all ARP requests with its client-side physical address. In this way, the clients will address all of their low-level packets (MAC-layer) to the System server. The System server would appear to every client as its gateway, as well as any local IP address. The ARP requests also let the System server know that the client that initiated the ARP request is on the client-side network, and it will modify its route table accordingly.

### IP Promiscuous Mode

Since the clients can have any IP configuration, it is required that the System client-side protocol stack be able to process packets that have a source address off the client-side subnet (the client-side adapter would have an IP configuration for a subnet). Generally, the TCP/IP stack would reject any IP packets from a source that is off their subnet. The System overcomes this by storing the IP packet's original source address and changing this to have a source address to that of the client-side adapter.

### DNS Processing

Internet addresses are typically mapped to domain-names. These are used as “friendly” alternatives to IP addresses such as microsoft.com or linux.org. Requests are made to DNS servers for the IP addresses that map to the appropriate domain-names. It is expected that the typical client be configured for a local DNS server. In any event, the DNS server that it is configured for would provide the same services as any other DNS server except in the resolution of local and/or private domain-names. Since these domain-names would not be local when using the System (mobile client), resolution for these would not be required.

Because of this, all DNS queries are transparently proxied to a DNS server accessible to the System server. If the name is not resolved, it is assumed that the DNS request was for that of a local or private IP address. In this case the System returns the System client-side IP address as it attempts to emulate any local machine. A common occurrence that falls in this category would be to resolve the specified HTTP proxy.

### Protocol Services

The low-level services that the System provides are required for all IP communication by clients to the server-side. These include the ARP spoofing and DNS spoofing, which are the basic services that allow the clients to communicate through the System server as mentioned previously. The System server must handle each protocol as a special case. There are some similarities however.

### Transparently Proxied Protocols

Since any routing tables would not know the proper routing to the mobile the System clients, the System communicates to the desired address for the clients. In some instances, a proxy is specified for the particular application. HTTP is an example of a protocol that supports the use of a proxy. Many protocol standards do not support proxies (such as FTP or POP3). The System behaves as a transparent proxy for any non-proxy protocols. These services can be divided into two general categories: single-port protocols and multiple-port protocols.

### Single-Port Protocols

Some protocols initiate communication on one particular IP port, and then proceed to communicate solely on that port. An example is HTTP where a client initiates a connection to (well-known) port 80 and the entire session proceeds to use that port. The client keeps the same ephemeral port number for the HTTP server to communicate with it. It is possible to specify different port numbers for HTTP servers to accept connections on. The System utilizes packet filtering to accomplish this. A determination would be made that a particular packet is an HTTP request, and the appropriate port serviced as an HTTP connection. Other protocols would have to have similar filters for complete service.

For these protocols that have the entire IP session over one consistent port, the System replaces the source address of the client's packets to that of the server-side adapter and simply forwards the datagrams to the appropriate destination. For connections that have been specified by the client as proxy connections, these would be handled by a regular proxy application designed to handle that particular protocol (by converting the client's data that has been formatted for proxy-style communication into non-proxy-style initiated by the proxy). This could be a 3^{rd} party proxy application or an added part of the System.

These types of protocols behave similarly and thus they can all use a common routine to provide the transparent proxy servicing of those protocols.

Single-port protocols, as mentioned previously, are connections to a server on a specific port. In this case, a monitor would have to be enabled to look for connection requests to that port, and to be able act as a proxy for that communication. This would mean a different source port would be used for the server-side connection than on the client-side. A mapping would have to be put in place to properly format the packets belonging to the client that initiated the communication.

Some single-port protocols are implemented differently from a service perspective. For example, SMTP (the standard protocol for sending email) servers typically only service requests from addresses that are granted access. Thus, not everyone can use an SMTP server to send email. Since this restriction is in place, a System client will not have access to an SMTP server. The solution is to have all SMTP traffic redirected to an SMTP server that grants access to the System server and so allowing System clients to be able to send email.

### Multiple-Port Protocols

Multiple-port protocols are typically ones that initiate a control connection on a (well-known) port which can spawn other connections on other (typically ephemeral) ports specified by information agreed upon by the control connection. Examples of protocols that behave in this manner are FTP and H.323. For an FTP session, the control connection is initiated on (well-known) port 21, and a new connection is created for any kind of data transfer on an ephemeral port. The port for the data connection is specified in the control connection. This is extracted by the System and used to provide the transparent proxying. Each of these protocols behaves significantly, and thus a custom procedure would be appropriate for each one.

Multiple-port protocols are more complex than the single-port protocols. Port numbers for subsequent connections are specified within the original connection. Some protocols allow for many such dynamic connections to be formed for each protocol session. The System has a handler for each such protocol that could read the control information and then handle each other desired connection. Since the System server takes an active, though transparent, part in the particular protocol session, it requests different session parameters for performance reasons. For example, one client should not be able to have a session that requires many ports when free ports may be scarce. Another reason would be to specify a large bandwidth to accommodate some levels of QoS that would result in the other clients from suffering.

### Secure Protocols

Protocols that require some form of encryption and/or authentication are quite popular for certain applications, such as VPNs. Typically, this involves the encrypting of some portions of the IP header, and convolutional checks on the entire IP packet. Since The System modifies header information in order to proxy IP protocols, the System specifically supports these kinds of secure protocols in the appropriate protocol handlers. For example, if the header information is encoded by means of a checksum within the packet, the handler for that protocol is able to reform the packet and insert the appropriate value for the checksum that is correct for the new header information.

Some protocols can specify a secure connection in the initial handshaking phase. If desired, the System can suggest the session parameters as to not specify any kind of secure connection if it is impossible for the System server to properly proxy these protocols.

### Logging and Statistics Gathering

Information for each current IP connection is stored for use by the appropriate component that handles that connection, and made available to other components that require it. When the connection is terminated, this information can be erased and the space used to store it freed for use later. Some IP connections do not terminate gracefully. For example, there is no way to determine the end of a typical UDP session. Other network sessions that normally give indication of termination (such as a TCP connection) may be abnormally terminated for a variety of reasons. These include physically disconnecting one party, network equipment going down, or a client system crashing due to some fatal OS problems. This can happen far too frequently to ignore. Thus, some automated housekeeping duties are incorporated into the System that will make a decision that a stagnant connection has been abnormally terminated, or does not give any indication of termination.

The simplest method of implementing this is to use a timer that, after a fixed period of inactivity, a session is considered finished and the data associated with that connection may be discarded and memory recovered. Of course, any other method can be used in place of the simple timer that would deal with each protocol and/or service individually. It is to be expected that different upper-level protocols will produce different traffic patterns, and some would be idle for an extended period of time. An artificial intelligence algorithm can be used to dynamically alter these timers for each individual connection or type of connection.

The System software supports administrative information services including logging and statistics reporting. The logging includes interesting events and can be output to the console, to a file, or another output device (such as over the network). The monitored statistics includes the usage and allocation of resources (bandwidth, open sockets, etc) and client information (number of clients, connection time, bandwidth usage, MAC address, etc). A useful interface for the monitoring of this information and general administration of the System software is SNMP.

### Billing

The System provides services to the clients by pushing these to the clients. Clients can be introduced to an information screen as they begin their session by intercepting their first connection (HTTP, Telnet, etc) and adding this information to the incoming data stream. In the case of HTTP, this can be in the form of inserting a simple JavaScript command. This would open a new browser window and display another web page—one with information for the client, advertising, and/or any other use.

This presents an interesting method of making clients view certain information, including advertising, in order for them to gain access to System services. The client could be required to fill out a short form (which could be sent to a web-based database application) and the System would know to enable services for that client. Clients that did not fill out the form (and therefore not view the information) would not be allowed any kind of System access.

### System Component Integration

Putting the aforementioned services together creates the System. Low-level signaling components allow for the System server to promiscuously read any IP traffic on the client-side. The higher-level services deal with the proxying of the protocols and mapping the responses from the server-side to the appropriate client. There are also maintenance processes that deal with monitoring the other System services, logging events, billing, the gathering of statistics, support for remote management, and connection data clean-up (for expired connections).

The System consists of several architectures that solve a variety of problems such as the duplicate IP address problem.

### Method to Handle Duplicate IP Addresses

IPv4 addressing (4 bytes) does not allow for enough unique IP addresses so that each computer interface is given an IP address which is globally unambiguous. This is further worsened by the fact that some IP addresses are reserved (e.g. 127.127.127.127 for loopback) and others are divided into IP address classes that can potentially waste host addresses. Although wasted IP addresses, such as those used in Class A IP addresses, have been recycled recently¹, there are still too few addresses to go around. This is one of the main drivers for the standardization and implementation of IPv6 (IPng), which uses 128 bit addresses². ¹This activity was completed in 1995 [28]. ²RFC2101 [30] is a good reference for the state of IPv4 addresses today.

In addition, intranets (i.e. corporate networks) may if necessary legitimately re-use a subset of the IPv4 address space, forming multiple routing realms. At the boundary between two (or more) routing realms, a spectrum of devices (i.e. gateway servers) exists that enables communication between the realms [29]. Organizations use registered IP addresses (for example a Class C address) to provide connectivity to the Internet, but may use IP addresses which are meaningless to the outside world on the other side of their firewall gateway servers. This means that the situation may arise when two or more clients visiting a hotel or conference center have the same IP address, as in FIG. 37 below.

If all IP addresses had a uniform chance to occur in duplicate, this occurrence would be considered too rare to address as a serious problem. However, it so happens that the Internet Assigned Numbers Authority (IANA) has reserved the following three blocks of the IP address space for private intranets [29]:

| | |
|---|---|
| 10.0.0.0 | 10.255.255.255 |
| 172.16.0.0 | 172.31.255.255 |
| 192.168.0.0 | 192.168.255.255 |

These IP addresses may be used for hosts that do not require access to hosts in other enterprises or the Internet at large, often referred to as category 1 hosts, or hosts that need access to a limited set of outside services (e.g., E-mail, FTP) which can be handled by mediating gateways (e.g., proxy servers), often referred to as category 2 hosts. The System is focused on category 2 hosts. Therefore, the chance of encountering two hosts with the same IP address is not so remote.

The occurrence of a duplicate IP addresses on the client side of the System server can be important point of failure. This section examines the impact of this scenario and what steps can be taken to provide a solution.

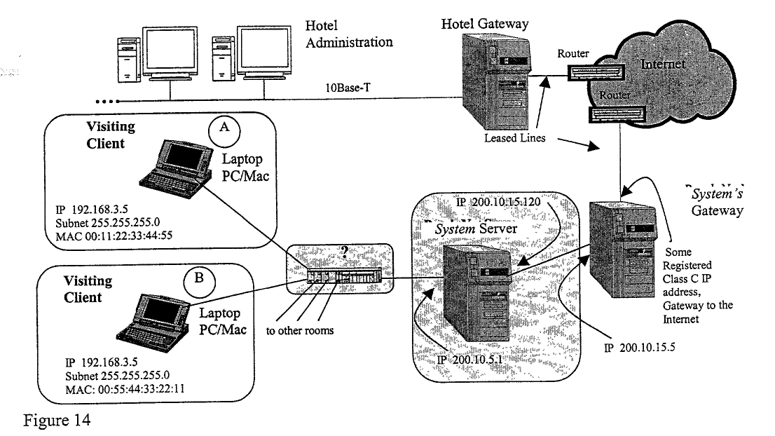

There are two fundamental obstacles to overcome in the scenario of duplicate IP addresses like the one shown in FIG. 14. The first problem has to do with getting frames back to the visiting clients from the System server. This problem requires more modifications to the behavior of the System server itself. The second problem has to do with the nature of broadcasts over a LAN (hereon referred to as the “broadcast domain problem”). This problem requires a modification to the architecture of the network to which the visiting clients connect (i.e. the box labeled with a ‘?’ in FIG. 14).

In FIG. 14 two visiting clients, (A) and (B), each are configured with the same IP address, 192.168.3.5, and are both trying to use the System server to connect to the Internet. Consider what would occur if the System server had a packet to send back to the client (A). There are two possible outcomes. In the first case, the System server's ARP table already has stored the MAC addresses of both client (A) and client (B). The packet gets sent back to whichever client had the first entry in the ARP table at the System server. If client (B) happened to be first, then the packet would get delivered to the wrong host and would most likely be discarded since client (B) wouldn't have a connection open on the TCP/UDP port specified in the packet received from the System server. In the second case, the System server's ARP cache is empty and an ARP request is issued for the MAC address of client (A), IP 192.168.3.5. Both client (A) and client (B) will respond to the ARP request. Whichever one responds first, will receive the packet destined for client (A).

The solution to the problem of getting packets destined for a client with the same IP address as another client is to correct the result returned when the System server does a lookup in its ARP table or issues an ARP request. This is accomplished by storing the 6 byte Ethernet (MAC) address of all clients using the System server for the duration of each connection. Once stored, this Ethernet address is used to overwrite all destination Ethernet addresses entered into packets by the OS using traditional ARP services before the packets are sent out to the clients.

In order to achieve this a new field is required in the DestAddrPool structure in the System NDIS Intermediate Driver. Specifically, for each TCP or UDP connection entry in the table a Source Hardware Address must be stored in addition to the Source IP, Source Port, and Destination IP fields. The modified table will contain the following fields: Hash Code, Source IP, Source Port, Source Hardware Address, Destination IP, Flags, Time to Live.

Whenever a connection is entered by the System into DestAddrPool as described previously, the source Ethernet address is stored along with the rest of the connection information. This is possible since the entire Ethernet frame, including header, is passed to the intermediate driver from the NIC miniport.

Consider again the scenario where the System server wants to send a packet to client (A) in FIG. 14. Assume the OS of the System server has an internal ARP table which looks like:

| IP Address | Hardware Address |
|---|---|
| 192.168.3.5 (B) | 00:55:44:33:22:11 |
| 192.168.3.5 (A) | 00:11:22:33:44:55 |

and a DestAddrPool (simplified) which looks like:

| Source IP | Source Port | Source Hardware | Destination IP |
|---|---|---|---|
| 192.168.3.5 (B) | 2345 | 00:55:44:33:22:11 | 192.168.5.2 |
| 192.168.3.5 (A) | 4321 | 00:11:22:33:44:55 | 192.168.3.89 |

The TCP/IP protocol stack at the System server will send a packet to the System NDIS Intermediate Driver with an Ethernet address equal to client (B)'s MAC address (00:55:44:33:22:11) since the ARP table happens to have client (B)'s entry listed first. However, once the System NDIS Intermediate Driver intercepts the packet from the transport driver it does a lookup in DestAddrPool using the destination IP address and destination TCP/UDP port number of the received packet to determine if the source IP address of the packet needs to be changed to equal the IP address which the client was expecting to hear back from. In addition to retrieving the destination IP address from DestAddrPool at this point, the Ethernet address can also be retrieved. The System NDIS Intermediate Driver then simply replaces the destination Ethernet address of the packet received with the source Ethernet address retrieved from DestAddrPool for this connection (client (A)'s MAC address: 00:11:22:33:44:55). The Ethernet frame will now be sent on to the correct client (A) regardless of the confusion introduced by the ARP lookup.

Note that the lookup in DestAddrPool used to retrieve the source MAC address relies on the source TCP/UDP ports being different for the case where both source IP addresses for two connections from two different computers are the same. If both client (A) and client (B) have the same IP address and choose the same source TCP/UDP port by happenstance then the lookup in DestAddrPool will not necessarily give the correct result (i.e. the first entry in DestAddrPool will be returned). However, the chances of this occurring are infinitesimal. Therefore, this problem does not warrant a fix. In any case, if this should happen, the connection for one or both of the clients will simply time out. After the time out a new session can be attempted by the user, and so on. Eventually the two clients will choose different source TCP/UDP ports since this number is chosen pseudo-randomly.

Also note that the Frame Check Sequence (FCS) of the Ethernet frame, which is calculated using a 32-bit Cyclic Redundancy Check (CRC-32) algorithm, need not be calculated when a new destination Ethernet address is entered by the System NDIS Intermediate Driver since this is generally done in hardware by the network adapter (NIC).

### Method to Solve the Broadcast Domain Problem

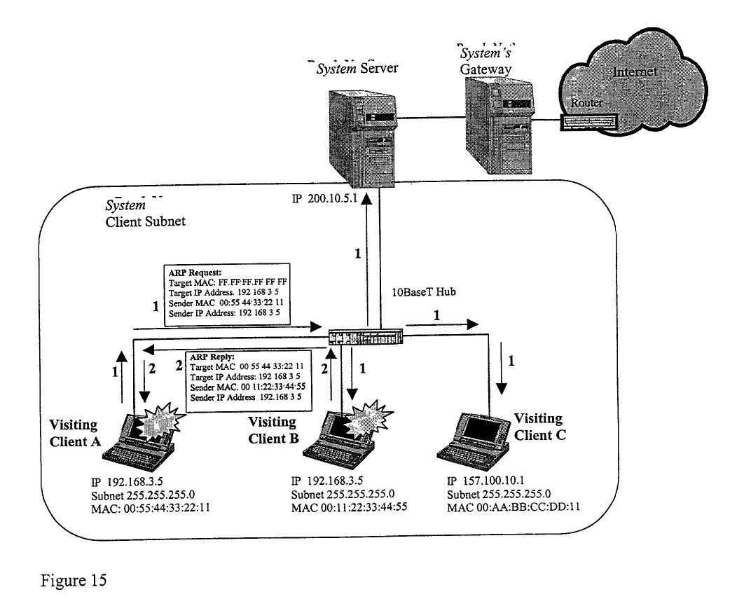

There is a more difficult problem to overcome than returning packets to the proper client from the System server. This problem results from the fact that all clients on a LAN are in the same “broadcast domain”. This means that all Layer 2 broadcast packets are received by all other hosts on the same LAN as the host that originated the broadcast, even if they are in separate collision domains (i.e. separated by a bridge or Layer 2 switch such as an Ethernet switch). Broadcast Ethernet frames issued by the System server are not a concern since the only broadcasts it will send out are ARP requests and no error occurs if more than one host replies. We have shown above how changes to the System server can be made to combat incorrect ARP replies. However, broadcast packets sent out by the client machines can be devastating if there are multiple clients with the same IP address. In particular, when a computer boots on a network it announces its IP address and Ethernet address by sending out an ARP packet. This is done so that other machines can cache this information, but also to detect for duplicate IP addresses on the network (precisely what we are trying to make transparent to the client!). Consider the LAN on the client-side of the System server shown in FIG. 15.

Assume that client (B) and client (C) are already booted up and using the System server. Client (A) then boots up after plugging in to the Ethernet port in his/her hotel room. As part of the boot sequence, client (A) sends out an ARP request with target IP 192.168.3.5. Upon receiving an ARP request from (A), client (B)'s network applications will stop functioning due to error messages received from the TCP/IP protocol stack indicating that there is another machine on the network using the same IP address and that user (B) should contact his/her local administrator immediately. At the same time, an ARP reply will be sent (non-broadcast) from client (B) to client (A) with a target MAC address equal to client (A)'s MAC address and a target IP address equal to that of client (A)'s IP address. This ARP reply will also contain a sender MAC address equal to client (B)'s MAC address and a sender IP address equal to client (B)'s IP address. This response from client (B) tells client (A) that another client has the same IP address as itself. The TCP/IP protocol stack at client (A) will present the user with an error message and will not allow the network applications to function on this computer either. Therefore, after the client with the duplicate IP address boots up on the System client network; both clients will not be able to use their network applications. It is feasible that one of the computers may still work, depending on the implementation of the TCP/IP protocol stack. This scenario has not been encountered in lab experiments. Even if network operations on one computer still function, however, the error message will always appear, disrupting whatever activity the user was currently doing. This is certainly no longer a transparent service to the user.

### Separate Client Subnets Method

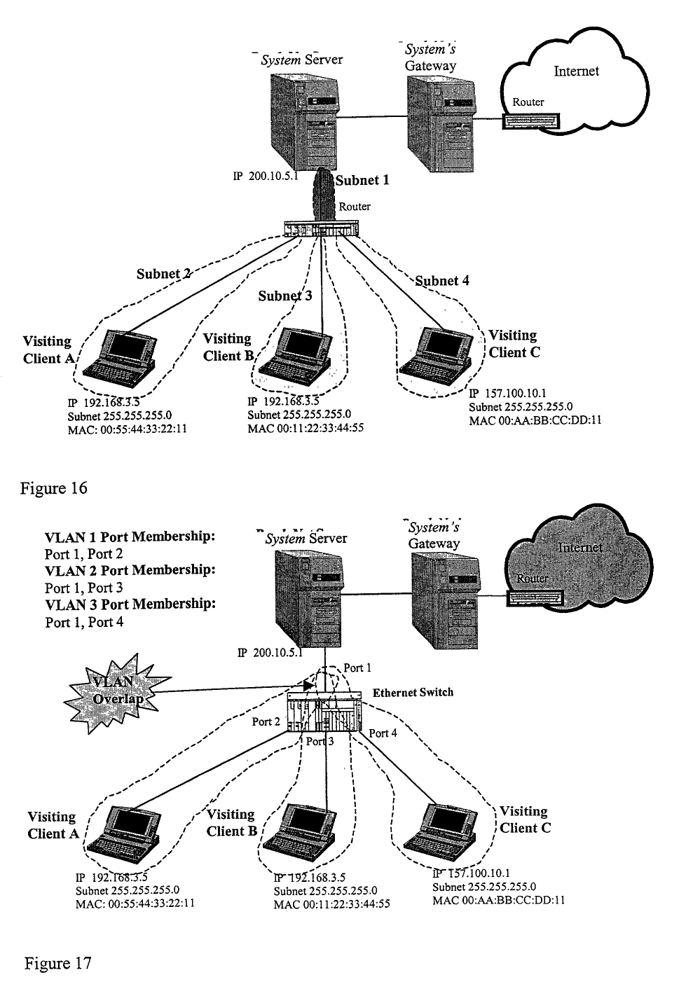

The first obvious solution to this problem would be to separate each hotel room into a separate subnet, wired into one router, which would then connect to the System server as shown in FIG. 16. However, the System server requires that it be on the same LAN as the clients. This is due to the fact that no Layer 3 routing mechanism can exist between the client and System server since the client can have any IP address and may wish to connect through a proxy server with any IP address. No routing table can be defined at the router with a default route set as all of its interfaces. Besides which, if on a different subnet, the ARP Spoofer cannot pretend to be the server which the client is trying to connect to since all ARP broadcasts would only be sent out on the clients network segment.

### Ethernet Switches and Virtual LANs (VLANs) Method

The solution is to use of an Ethernet switch (a.k.a. workgroup switch, LAN switch, switched hub, or Layer 2 switch). Ethernet switches are a relatively new class of interconnect product which provide the capability to increase the aggregate LAN bandwidth dramatically, because it allows for the simultaneous switching of packets between ports [3]. Each port on the Ethernet switch is attached to a shared segment (in our case a single client). Each shared segment can be allocated an internal bandwidth equal to 10 Mbps, allowing for an aggregate throughput of several times that of a single 10Base-T shared segment. A similar solution for the realization of increased aggregate bandwidth is provided by segmentable hubs [32].

Ethernet switches in combination with Virtual LANs (VLANS) provide a level of security at the Layer 2. A VLAN can be roughly equated to a broadcast domain. VLANs can be seen as a group of end stations, perhaps on multiple physical LAN segments, that are not constrained by their physical location and communicate as if they were on a common LAN. How membership to a VLAN is defined is for the most part left up to the vendor of the Ethernet switch, but there are a few common ways in which membership can be defined: (1) membership by port group, (2) membership by MAC address, and (3) layer-3 based VLANs [31]. Many initial VLAN implementations defined VLAN membership by groups of switch ports, but more recently VLAN membership based on MAC addresses has emerged. However, MAC addresses are hard-wired into the workstation's NIC so this method can be cumbersome to administer. VLANs based on layer-3 membership take into account protocol type. In this scenario, a switch inspects a packet's IP address to determine VLAN membership. No route calculation is undertaken, RIP (Routing Information Protocol) or OSPF (Open Shortest Path First) protocols are not employed, and frames traversing the switch are usually bridged according to an implementation of the Spanning Tree Algorithm. Therefore, from the point of view of a switch employing Layer 3-based VLANs, connectivity within any given VLAN is still seen as flat, bridged topology. Let us look at how segmenting the clients off into separate VLANs is used to restrict the broadcast domain.

It is immediately clear that separating the clients into VLANs using either the Layer 3 approach or the MAC address approach is not viable. This is due to the fact that the clients dynamically adding and removing themselves from the System client network will have all sorts of IP address and MAC addresses, and these clients will be constantly changing. This leaves us with the option to use port membership. Consider FIG. 17, which illustrates the implementation of the System client network using an Ethernet switch and port-based VLANs.

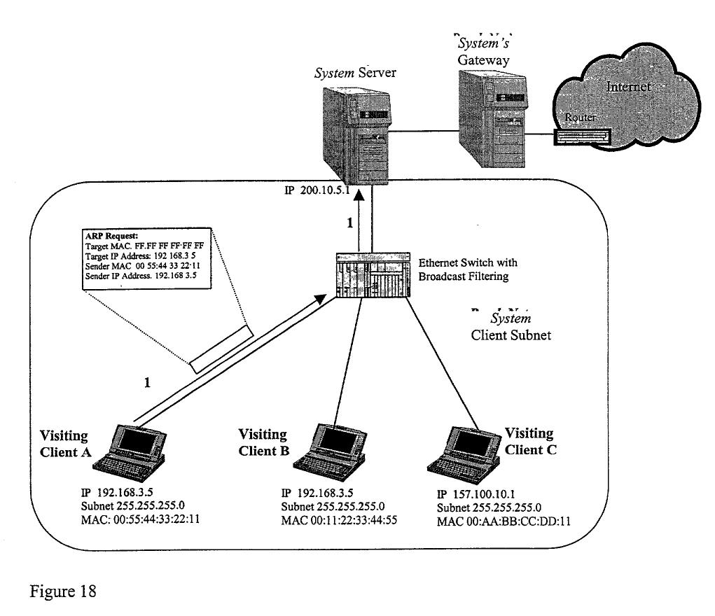

It is required that all of the clients be in the same broadcast domain as the System server so that the ARP Spoofer can do its job. However, this implies that the System server must be part of each of the VLANs (VLAN 1,2 and 3 in FIG. 18). First, we are assuming that we can even find an Ethernet switch which allows one port to be a member of multiple VLANs. Generally, “[d]efining VLANs purely by port group does not allow multiple VLANs to include the same physical segment (or switch port)” [31]. At the time of submission of document, a product which supports such a feature has not been discovered. Even if a hierarchy of VLANs is created, at some point they all must connect to the System server. Therefore, even if we assume that an Ethernet switch does exist or is developed which allows one port to be a member of multiple VLANs, a second problem arises. If one computer is on all VLANS, then all computers on all VLANs are logically in the same broadcast domain. This brings us back to the same broadcast domain problem. It is possible that an Ethernet switch may perform its port-to-VLAN association in such a way that broadcast messages are not associated with VLANs other than the one it was intended for, even if one of the hosts which receives the broadcast is part of multiple VLANs. This specifies a new product.

### Broadcast Filtering Method

Despite the fact that VLANs may not provide us with a solution due to our very specialized requirement that only certain computers on the System client LAN can receive certain broadcasts, Ethernet switches may still provide us with another viable, however unorthodox, solution. Layer 2 switches normally do not filter LAN broadcast traffic. However, this does not preclude that an Ethernet switch cannot be either purchased or developed which does provide this functionality. At the time of submission of this document, a Layer 2 switch which filters broadcast LAN traffic has not been discovered. Therefore, the high-level algorithm for such a feature on an Ethernet switch will be discussed here. Development of a proprietary Ethernet switch would require that custom network components be added to the System solution “package” (which already consists of the System server software and a custom proxy program which is required on the System gateway server).

It is recommended that the construction of a broadcast filtering Ethernet switch be done on top of an Ethernet switch which already supports some level of Layer 2 or Layer 3 packet filtering (e.g. Ethernet switches which support VLANs based on a MAC address membership scheme or a layer-3 membership scheme). The algorithm is quite simple. The Ethernet switch would be required to be pre-configured with the IP address of the client-side adapter of the System server. Then, for all ports connected to the visiting clients, all Ethernet frames with destination MAC address equal to all 1's (broadcast) will be filtered. The switch inspects ARP packets and other broadcast Ethernet frames to determine if the senders IP address is equal to the IP address of the client-side adapter of the System server. If so, then the frame is sent on to the client. If not, then the broadcast frame has originated from one of the client machines, and the broadcast frame is sent on to the System server only. This solution is illustrated in FIG. 18.

The broadcast filtering Ethernet switch a very attractive solution to this broadcast domain problem. If development is required, it should be minimal since an Ethernet switch already has inherent frame filtering capabilities so that it can do Layer 2 switching. A hotel which decides to implement the System service will also need to purchase new network components for their System client network regardless, so it should not matter to them if the components are purchased from the same firm which is supplying them with the System components. Also, the use of a Layer 2 switch is recommended to construct the System client network due to their inherent host isolation properties which is important when considering security. This will be discussed in a separate section on security in this document. This is the recommended solution for the broadcast domain problem. However, there is one more elegant solution, however cost-ineffective.

### Ethernet-to-Ethernet Adapter Method

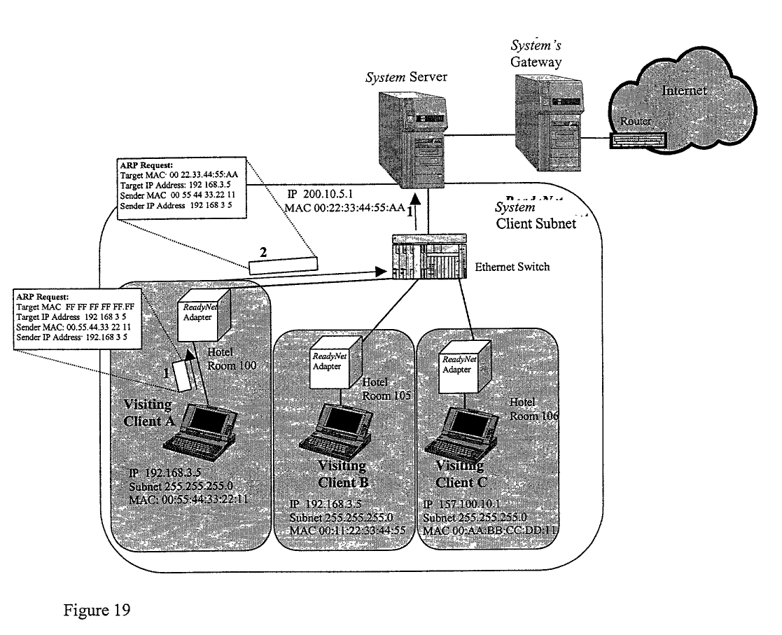

An alternate solution avoids exploring the inside of a LAN switch. In this case, the visiting client plugs his/her computer into a small box in the hotel room which functions like an Ethernet-to-Ethernet adapter. Each room would have such a device. The box filters all Ethernet frames being sent out by the computer. If the frame is a broadcast frame, the destination MAC address (currently all 1's) is replaced with the MAC address of the System server. All broadcast messages are now specifically directed towards the System server. This solution is depicted in FIG. 19.

The implementation of the Ethernet-to-Ethernet adapter is the solution. The advantage of such a development undertaking, however, is that it could be done by any 3^{rd} party vendor, not just those that already manufacture Ethernet switches. This solution also provides us with an interesting alternate solution to the System billing problem introduced in later in this document in the Billing section. This solution, however, may get expensive for the hospitality center deploying the System since each room would require special hardware and special configuration. Another disadvantage of this solution is that the MAC address of the client-side adapter of the System server must be known by all of the System Ethernet-to-Ethernet adapters in the hotel rooms. This is more administration-intensive than the Ethernet switch with broadcast filtering approach. An Ethernet switch would only require the IP address of the System server. As network adapters change on the System server, no reconfiguration at the Ethernet switch would be required since the same IP address could be reused. However, a new destination MAC address would need to be configured in the adapter for each new card installed at the System server.

As a final note, the solution proposed in the section on the Multiple Network Adapter System Implementation inherently does not suffer from the broadcast domain problem since each client is on it's own separate network connected to a separate network adapter which resides on the System server.

### Other Considerations

Even having completed the development required to solve the duplicate IP address problem outlined in the previous section, there are still a number of IP addresses which will cause problems when a client connects to the System server.

The first problem occurs if the visiting client has the same IP address as that of the client-side adapter of the System server. In this scenario, the broadcast domain problem is still encountered. This is due to the fact that all broadcast ARP requests sent out by the client must be intercepted by the System server. When this occurs, the visiting client will likely crash the System server and disrupt service for all of the clients. To prevent the System server from being brought down, the broadcast filtering at the Ethernet switch may include a mechanism by which it does a check on all frames received on the segment which contains the System server. If the sender's IP address is equal to the IP address of the System server, then the frame is discarded. In this manner, the visiting client will not receive any service from the System server, but at least the other visiting clients will not be disrupted.

The second problem occurs if the visiting client has the same IP address as that of the gateway server used by the System. Recall that the routing table in the System server must be set up so that the default route is configured for the client-side interface of the System server. To get towards the gateway server, a static route is set up specifically to connect to the IP address of the gateway server specified by the proxy program. Consider now a visiting client that has the same IP address as the gateway server. When a packet is received at the System server from the gateway server and the proxy program tries to send it back to the client, the OS will route the packet back to the gateway server since there is a static route set up to route packets destined for this specific IP address out the gateway-side interface of the System server. The gateway server will then discard the packet when it receives it and the packet will be lost.

One possible solution to this second problem could be borrowed from the “IP address pool” concept introduced later in this document. In this scenario, each client is temporarily assigned an IP address from a pool, allowing static routes to be set up for all possible connections. This makes client reuse of the same IP address as the gateway server impossible. However, it does not prevent the loss of service scenario presented by the first problem.

In order to combat the problems where the visiting client has the same IP address as either the client-side adapter of the System server or the gateway server, it is recommended that registered IP addresses be used for both of these subnets. That is, the IP address of the client-side adapter of the System server should belong to a registered IP address class and the gateway-side adapter of the System server and the System-side adapter of the gateway server should belong to the same registered IP address class. These registered IP address classes should be outside the range specified by IANA for private use. This will minimize the chances of encountering duplicate IP addresses.

Note that no problem should arise on the System client network if a visiting client tries to connect to a destination IP address (either a proxy server or an actual destination server) which also happens to be the IP address of one of the other visiting clients or the System server. This is because the visiting clients are on different segments of an Ethernet switch, which uses MAC addresses to control access to certain ports. MAC addresses are unique and therefore the Ethernet switch will not know that there is any IP address duplication. Of course, this is assuming that broadcast filtering has been implemented on the Ethernet switch.

Finally, note that the custom proxy program introduced previously uses the source IP address and source TCP/UDP port of the visiting client to lookup the actual destination IP address from DestAddrPool of those clients trying to establish a connection via a non-proxy request. If a visiting client has the same IP address and uses the same source TCP/UDP port as another visiting client, then the lookup in DestAddrPool may give the custom proxy program the incorrect result. However, as already mentioned in the previous section, the chances of this occurring are infinitesimal. Therefore, this problem does not warrant a fix. This scenario will also cause problems for the System NDIS Intermediate Driver, which performs lookups in DestAddrPool.

### Method for Secure System Access

Security is always a major concern when accessing the Internet. There are varying opinions on the nature of security in the TCP/IP environment. The following quote typifies the truly skeptical:

“Some network engineers say that the only way to ensure a networked computer systems security is to use a one-inch air gap between the computer and the network; in other words, only a computer that is disconnected from the network can be completely secure from network attacks”[6].

This condition may be sufficient, but it is certainly not necessary. Generally there is a trade-off between offering functionality and introducing vulnerabilities. However, in the case of the System a great deal of functionality can be delivered while still maintaining good levels of security. This section looks at how the System can ensure the logical isolation of one visiting client from the other visiting clients to a hotel or hospitality center. Also, it examines how the System can reduce the possibility of outside network attacks, which could be harmful to both the System server itself and to the visiting user. Finally, the impact of users who make use of Virtual Private Network (VPN) services and other private network authentication schemes is discussed.

### Visiting Client Isolation

The use of a switched hub (Ethernet switch) to connect visiting clients to the System server ensures a good level of user isolation. Even if a visiting client has a network adapter in promiscuous mode, listening to all traffic on the LAN, the client will never be able to see any traffic from the other guests. This is especially true if the Ethernet switch uses the broadcast filtering mechanism described in the section on “Duplicate IP Addresses”. For in this case, not even broadcast traffic is sent out on all LAN segments.

However, there is not much that can be done to prevent “hardware address spoofing”[6]. To see how common it is for a network interface to be able to spoof the source hardware address, recall how a bridge works. A bridge not only puts its interfaces in promiscuous mode, but is also sets the hardware source address of packets sent out on its interfaces to match the hardware source address of the originating interface. A PC with two software configurable interfaces can be configured to be used as a bridge. This has a variety of malicious uses. Most NICs support source hardware address spoofing. Using hardware spoofing, a client could intercept packets by confusing the Ethernet switch.

### System Network Attacks

At first glance, the System solution does pose a security problem. Since the proxy must masquerade as all external systems, internal packet filters will typically need to allow IP traffic between internal and external IP addresses. This means that packet filtering security techniques would not be effective. However, a security mechanism may be introduced at the proxy server itself. Most commercial proxy programs come equipped with the ability to allow connections through only a certain number of interfaces. Development of the custom proxy program as discussed previously in this document would need to include such a security feature to prevent application-level network attacks. This would restrict access to the gateway server from malicious network hosts.

If the gateway server was the victim of a successful attack, the hotel guests would still be secure for three reasons: (1) neither the gateway server nor the System server know the actual IP address of the visiting guests, (2) the System NDIS Intermediate Driver must have a connection entry in DestAddrPool if a packet is to be sent to the visiting client, otherwise the packet is discarded, and (3) by addressing the visiting client the attacking host will not be routed to the System network, but rather the client's home network, to which the client is currently not connected. These three reasons may work in combination or alone to prevent malicious attacks. In any case, it is more difficult to attack a visiting System client than a host connected to a classical proxy server.

To track both internal and external network attacks, a logging capability is desirable at the gateway server to log all traffic coming out of and into the server.

### Security at the Client's Home Subnet

Many corporations employ a high level of security so that only authorized users from remote locations are able to access the corporate network. There are various ways through which this can be accomplished. However, Virtual Private Networks (VPNs) are transforming the daily method of doing business faster than any other technology [48]. This section introduces VPN and looks at how VPNs may be supported over the System solution.

All authentication technologies other than VPN are outside the scope of this document. In general, it can be said that any authorization scheme which requires user authentication based on source IP addresses will not allow visiting clients to access their home networks over the System. This is due to the fact that System proxies requests using its own IP address as the source address.

### Virtual Private Networks (VPNs)

Essentially, VPNs are private network overlays on the Internet. A VPN provides secured communications between several points, whether to remote sites or to mobile users. VPNs are becoming a popular method to reduce the costs which corporations incur to setup and maintain a WAN. The VPN typically attempts to satisfy the need of the mobile user who is configured for dial-up Internet access (i.e. using a modem or ISDN line) to connect to a larger corporate subnet securely [49]. This is very different from the System's primary application, which is to satisfy the need of the mobile user who is configured for connectivity to a corporate LAN to access publicly available Internet services. However, due to its growing popularity, its conceptual support over the System is interesting from a service evolution standpoint.

Although there are a dizzying number of methods for employing VPNs, two features are common among all of them: (1) authentication and (2) encryption. Stand-alone VPN technology can be purchased from companies such as Microsoft, Checkpoint, and Raptor. All implementations of VPN are proprietary (non-standard). One of the more publicized technologies available for VPN services is the Point-to-Point Tunneling Protocol (PPTP) used in conjunction with Microsoft's Remote Access Server (RAS Server) [49]. The PPTP specification was developed by the PPTP Forum, a collaboration between Microsoft and a group of several leading manufacturers of ISP equipment, including Ascend Communications and 3Com. PPTP will be used as an example of how a VPN is realized.

A typical PPTP client has the PPTP protocol installed on his/her laptop. This client dials up the ISP and establishes a Point-to-Point Protocol (PPP) session. The same client then dials a second time, concurrent to the PPP session, setting up the PPTP channel and contacting the remote NT Server 4.0 RAS Server. The RAS Server and the PPTP client exchange authorization information based on a unique key and a password. Once authenticated, the RAS Server accesses this particular PPTP client's encryption key (the encryption key is not sent out over the Internet for security reasons). The PPP packets are then encrypted and tunneled through the new virtual connection, and the client is now a virtual node on the corporate LAN, one that just happens to be located across the Internet. Note that in this scenario the point of entry into the Internet does not have to be PPTP-enabled [49]. However, if the client were not PPTP-enabled, the point of entry into the Internet would have to be PPTP-enabled.

The System does not support dial-up connections to the System server using PPP. However, the System supports VPN services for the Ethernet-based, VPN-enabled client on a VPN protocol dependent basis. The VPN server at the corporate LAN does not require that the mobile user authenticate himself/herself using a valid source IP address. All authentication information is in the tunneled portion of each packet. In addition, all tunneling/de-tunneling is done between the VPN server and the client. The only requirement for the System server is to provide the means for a communication path between the VPN-enabled visiting client and his/her firewall running VPN software over the publicly accessible Internet. Only minor development may be required on a protocol-by-protocol basis for the System server.

### Method for Deployment and Scalability

This section analyzes the scalability of System to meet the needs of larger hotels and conference centers. This section examines only how the System could be scaled in such a way that a medium-to-large hotel has full room connectivity to a System server with the further requirement that the guests' bandwidth needs are satisfied.

The System was originally intended for visiting clients using IEEE 802.3 10 Mbps Ethernet over a 10Base-T Ethernet medium. Although a 10Base-T LAN can be made quite large by stacking hubs or Ethernet switches, due to the poor transmission characteristics of unshielded twisted pair the maximum segment length from the Ethernet switch port to the host is 100 meters. This limitation is also imposed on the connection between Ethernet switches. In addition, if Ethernet switches are not used, the entire collision domain is limited by nature of Carrier-Sense Multiple Access with Collision Detection (CSMA/CD), which specifies a maximum network span for proper collision detection of 2500 meters. Therefore, for hotels which require several hundreds of meters of cabling, several Ethernet switches may be required to support connectivity to all of the rooms, and possibly several System servers to support them.

In addition to the physical cabling restrictions, there are bandwidth needs of the hotel guests to satisfy. As a rule of thumb, on a 10Base-T LAN with moderate usage, no more than 100 hosts should share that LAN. However, this is dependent on the types of applications being used by the visiting guests. In the case of the System, this will also depend on how well used the service is. For example, if only 10% of those rooms which support a System connection are actually using the service, more rooms may be able to be supported by the same System server.

Also, since a 10Base-T Ethernet switch can support aggregated traffic equal to more than 10 Mbps, IEEE 802.3 100Base-X (i.e. 100Base-TX or 1000Base-FX) may be used to connect Ethernet switches to the System server(s). Use of these technologies is possible since they also use the IEEE 802.3 MAC protocol and frame format [8].

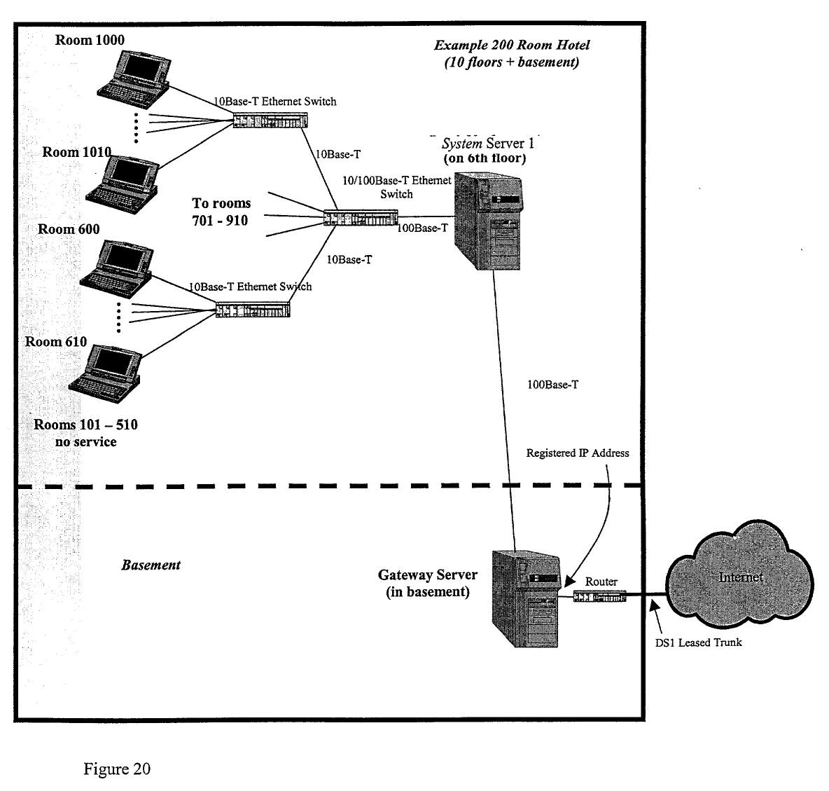

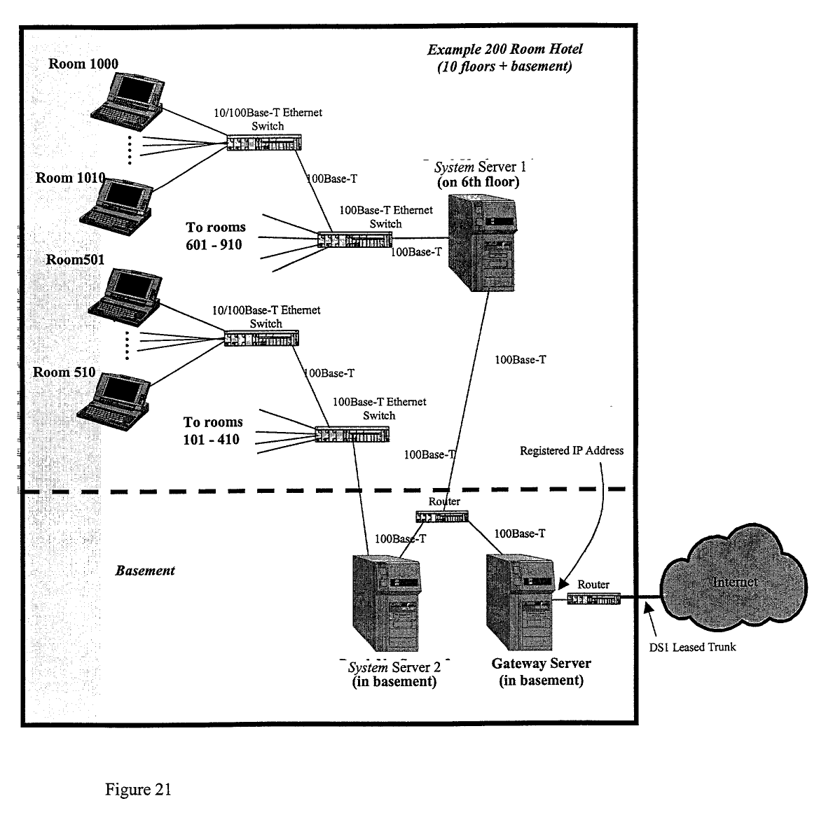

FIGS. 20 and 21 depict a proposed evolution plan for a System network for a large hotel (200 rooms). In Phase 1 (FIG. 20), the hotel introduces the services to only certain high priced suites.

In Phase 2 (FIG. 21), the hotel introduces the services to all rooms and provides higher aggregate bandwidth to support increased demand. Note again that this depiction does not include any potential capacity limitations introduced by the System, either the System server itself or the gateway server and may need to be revisited once thorough capacity testing under loading is done on the System.

As a further evolution to offer more bandwidth to the end user, 100 Base-T could be offered directly to each guestroom as well.

### Load Balancing and Redundancy Method

The network spoofing nature of the System server allows for an interesting feature: redundancy. Usually such a feature cannot be implemented in the Internet since hosts address servers uniquely using IP addresses. Traditional servers which support each other would have to both run simultaneously, and then host requests would be directed to either of the two servers thereby sharing the traffic load. However, the System allows for an idle redundant server to co-exist with the actual server.

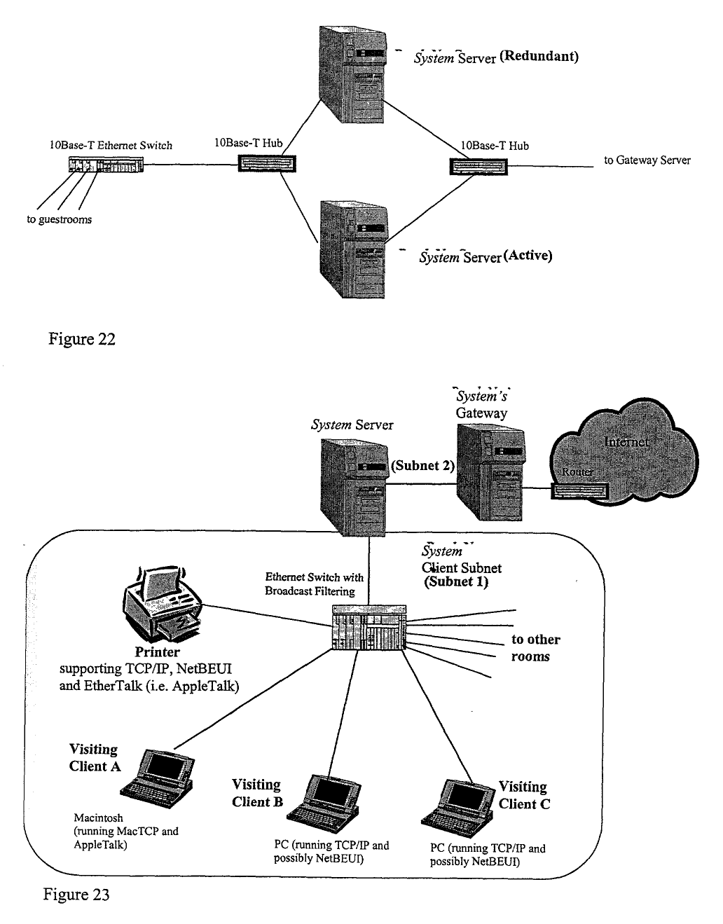

The System server simply listens for all broadcasts and then responds to them, pretending that it is the server which the visiting client wishes to communicate with. Now extend that concept to the architecture shown in FIG. 22.

To enable a redundancy feature, the redundant server monitors all traffic on the shared segment with the active System server. This is provided by connecting the two servers together with an Ethernet hub and leaving the NIC on the redundant server in promiscuous mode. Every time a broadcast request is issued on the server segment from a visiting client, then the redundant System server will start a timer. If the timer expires before a response from the System server is detected, the redundant System server begins to respond to broadcast requests with its own MAC address. Connectivity to the gateway server is provided by another Ethernet hub. It is important to stress again that such redundancy is only possible since both servers have the capability to spoof any network.

Of course, all connections currently using the originally active System server will be dropped when the switchover occurs. However, all connections can then be re-established with the redundant System server.

### Billing

Billing for usage is of primary concern to the proprietors of the hotels and conference centers which would implement the System service. It is a unique challenge, however, to charge a hotel room with which there can be any IP address or MAC address associated. In addition, once the hotel room is identified how should charges be computed, by connection time or by bandwidth usage? This section examines the problem of billing the visiting client for System services. Connection of the System network to the hotels administration network for integrated hotel billing is outside the scope of this document.

### Splash Page

For many hotels and conference centers, intercepting the outgoing connections of all of their guests presents an excellent opportunity for advertisement. Forced navigation of web screens during the logon process can be used to present branding, services, and advertising messages to users. This section examines how a web page can be forced to a visiting client's web browser when he/she first logs on to the System server. It will be shown in this section how this feature can be used to provide hotel billing information.

All IP packets received by the System server are inspected by the System NDIS Intermediate Driver. Therefore, an HTTP Request-URI message can be modified by the intermediate driver before being sent on to the TCP/IP protocol stack and then to the proxy program. If the System server is pre-configured with the absolute path to the hotel web page, then the first HTTP Request-URI message received from any IP address can be replaced by a new HTTP Request-URI message (determined by the pre-configured path) which points to the hotel's web page. As an example, consider the URL “http://www.cnn.com/” is what a typical home page may be configured to be on a visiting client's web browser. This request will be issued as soon as the visiting client starts the web browser.

However, the home page which the hotel would like forced to be presented to this user is on a different web server (e.g. “http://www.myhotel.com/”). The System NDIS Intermediate Driver will alter the HTTP Request-URI message before the packet is sent on to the TCP/IP stack (i.e. the transport driver).

Once received by the proxy program, the request will be sent to the proper web server and the web page of the hotel will be presented to the user. No connection information has changed, so the client's computer will actually think that it is downloading the web page which was originally requested.

In addition to modifying the packet, the driver maintains a dynamic list of all IP addresses it has seen recently and only force a web page on those IP addresses which are new. Otherwise, the hotel's web page will be forced upon the user for every HTTP request made.

The web page may reside on a web server within the hotel or on a web server provided through an ISP. Alternatively, a web server service can be left running on the System server(s). If the System server(s) stored the web pages, then a different web page could be loaded for different types of guests. For example, guests in the high priced suites could be offered a different choice of hotel services from the hotel web page than those guests who are in less expensive suites. Relying on the System server to provide the web page to the clients requires that the proxy program used (or developed) have a “bypass proxy for local (pingable) sites” feature for the WWW proxy service. WinGate 3.0 and most other 3^{rd} party proxies have such a feature.

### Identifying the Billable Hotel Room

There are a number of different methods of determining which hotel room to charge for System services. The goal is to make the process as convenient for the hotel proprietor and the guest as possible (i.e. largely automated), and still require that the visiting client have no knowledge of how his/her computer is configured. There are many different ways to accomplish this in an inconvenient manner. For example, a trivial method requires the visiting guest to ask to register an IP address at the front desk or call the front desk before using the service. The on-site System network administrator could then configure the System server to allow connections for that particular IP address. However, this would have to be repeated for each guest manually and also requires that the visiting clients know their IP address. Two methods are introduced for automatically determining the billable hotel room.

The First Method is an extension of the System Ethernet-to-Ethernet adapter concept first introduced as a solution to the duplicate IP problem shown in FIG. 19. By configuring each adapter with a unique key and tagging this key to all IP packets sent out by the visiting client's computer the System server could determine the billable room based on the unique keys received for different IP packets. However, this solution requires a great deal of intelligence at the adapter. In fact, some implementation of a protocol stack would be required to handle possible message segmentation and re-assembly. Such intelligence would make each adapter quite expensive. It would be better if in-room hardware was kept at a minimum.

The Second Method uses the ability of the System server to force a web page back to the visiting client. In this solution, the visiting client is required to begin a System session with a web browser. The first request for a web page is intercepted by the System server, as discussed previously in this document. The web page returned to the user is a logon screen. The logon screen requests the authorization key of the hotel guest. This authorization key is given to the guest at check-in along with the key to the hotel room. Once the authorization key is entered, the guest would click a “Connect” button. The System server then validates the authorization key and return the hotel web page to the user's web browser. There are actually two separate web pages being forced onto the user in sequence in this scenario. At this point, the guest could either request a hotel service from the hotel's web page or begin using other Internet services.

In order for the connection usage to be monitored, the authorization key (unique to a certain hotel room at any given time) and the IP address from which it originated must be made available to an application which monitors all connections and computes billing information. Various approaches to how this is done will be discussed in the next section.

This solution requires the System NDIS Intermediate Driver to authenticate authorization keys. Note that using a web-based logon mechanism requires that the visiting client use a web browser before using any other Internet services. This introduces a level of non-transparency to the System service.

### Method for Computing Costs Incurred

There are three different approaches that can be taken to computing costs incurred by the visiting client for System services: (1) charging by connection time, (2) charging by bandwidth usage, and (3) flat rate charging.

The first two approaches require that the packets being sent to and from the clients be monitored. This packet monitoring can be performed in the System NDIS Intermediate Driver. It is required, however, that each authorization key and IP address combination be made available to it. A table separate from DestAddrPool in the intermediate driver is maintained which would has fields for the source IP address, the authorization key (i.e. the hotel room number) and either the number of packets sent or the aggregated time of usage.

Method for charging by connection: The System NDIS Intermediate Driver starts a connection timer whenever the first packet is received from the visiting client (i.e. the first entry in DestAddrPool for this source IP address is made). However, the driver would have trouble determining the end of the System session since entries in DestAddrPool are always being created and destroyed. As an alternative, the sum of the TTL fields in DestAddrPool can be computed for all of the TCP sessions involving a particular source IP address.

Method for charging by bandwidth: It is simple enough to count packets sent back to a certain IP address at the intermediate driver. However, what is the going rate for a byte of data? Also, when does charging begin, before or after the hotel's web page is forced on the user? Finally, how should a user be charged for data that is corrupt or for unsuccessful web page downloads?

Furthermore, in both the case of charging by connection time and charging by bandwidth usage, when two clients with the same IP address but different authentication keys use the System simultaneously, one of these clients may end up paying for the other client's System usage. This is due to the fact that authentication key-to-IP address mapping is done solely on the source IP address of the both clients' packets.

Recommended Method: Simply charge a flat rate. That is, once the authorization key is received a certain daily charge is added to the hotel bill regardless of the level of usage. In this scenario, the fact alone that the authorization key was used to access the System must be made available to the billing system.

The typical System user connection experience is as follows:

1. The user plugs the laptop computer's Ethernet cable into a System jack.

2. The user starts the computer.

3. The user launches a web browser to connect to the Internet and the user is taken to the System “connect” web page automatically.

4. User clicks the “connect” button after agreeing to payment terms.

5. The hotel's web page appears, providing links to valuable services for guests and business travelers.

6. The user now has a high-speed Internet connection. The user can continue to web browse or run other services.

7. To terminate the session the user closes all network applications or turns off the computer. The configuration has not changed; so all settings are restored the next time the computer is turned on.

### Meeting Management Method

Meeting services could also be provided using the above billing solution. A group of business persons could pay a flat rate for the use of a conference room which would include Ethernet jacks for all of the laptops. The conference attendees would be assigned one common authorization key which they would all use to gain access to the Internet.

### Network Printing

One service which would be very desirable to both hotel proprietors and visiting clients would be the ability to send print jobs to a hotel printer. This would eliminate the need for clients to bring along a low-quality portable printer for business trips. Networked printers and their printer drivers are not standardized. This, compounded by the fact that both Macintosh computers and PCs will be using the System client network makes the problem non-trivial. Therefore, both types of print jobs will need to be supported.

The topology of a System client network which supports printing services is shown in FIG. 23. One of the key drivers for this configuration is the fact that it allows the printer to be located on the same logical subnet as the clients (Subnet 1 in FIG. 23). An alternative solution would be to locate the printer on the subnet with the gateway-side adapter of the System server (Subnet 2 in FIG. 23) or even directly connect it to the System server. The System server could then provide printing services to clients. However, this would only provide printing service for PCs. Macintosh client computers would not have access to a printer.

As illustrated in FIG. 23, there are several requirements which the network printer chosen for this task must comply with. Firstly, the printer must support a network interface card so that it can be directly connected to the LAN. Secondly, it must have multiprotocol support—the ability to handle print jobs on top of different network protocols. Specifically, at least support for TCP/IP, AppleTalk, and NetBEUI are required. Most printers support TCP/IP and IPX, and most also support NeTBEUI and AppleTalk. Finally, the printer must not require that the client computers install a printer driver which is not available from their OS. If a special disk is required to load the printer driver, the configuration-free nature of the System service is compromised.

The requirements for the clients are simply that local networking services be enabled on both PCs and Macintosh client computers. Typically, Macintosh computers use AppleTalk for network file sharing and network printer services. PCs typically use NetBEUI for network file sharing and NetBEUI or TCP/IP for network printer services. Any other type of protocol must be supported by the printer if it is to be supported for printing services on the System client network.

In order for a client to print using the configuration just outlined, a client must add a network printer as normal. If on a PC running Windows 95/98 or Windows NT, the client must go to “Start/Settings/Printers/Add Printer” and follow the normal procedure to install a network printer. When the client chooses to “browse” for the network printer to add only one should be displayed: the printer on the System client network. A similar procedure would be required for a Macintosh client computer. Note that the requirement to add a new network printer does compromise the transparency of the System service somewhat. However, this step is necessary to provide this functionality.

An obvious concern with this proposed network printing scheme is the fact that one printer would be required for every System server (i.e. one printer for every System client subnet). A second concern is security. Since the client computers must locate the network printer, broadcasts must be sent out on the System client subnet. Recall, however, that broadcasts cause potential duplicate IP collisions and also allow other client computers to obtain information about the transmitter of the broadcast. A broadcast filtering Ethernet switch must be used here. In this case, however, the functionality of the broadcast filtering Ethernet switch must be altered such that all broadcasts are not just directed towards the System server, but also towards the printer. All other segments are restricted from the broadcast traffic.

Charging for printing services can be done on a per-page basis. The printer(s) can be located at the front desk of the hotel. Print jobs could be picked up and billed to the hotel guest manually. Note that the authentication key method introduced in the section Identifying the Billable Hotel Room cannot be reused here since the System server does not get involved with network printing services. One method is to send a print job identification code to the user after the print job has been sent. The user could then use this code to identify his/her print job at the front desk.

The System can also emulate a printer server that a PC is trying to locate using NetBEUI protocol. The System will then reply with it's own MAC-address and handle the printing job as if it was the printer required by the client.

### Network Management Method

Most hotels or conference centers do not want to be bothered to monitor the performance of or troubleshoot their System servers. Rather, it would be preferable if the service provider who sold the service to the hotel or some 3^{rd} party could install and provision the system, and then monitor performance and troubleshoot system problems. In order to facilitate this, a mechanism for remotely monitoring the System is desirable. Imagine the scenario where a service provider distributes System servers throughout an entire geographic region and has a centralized network management center from which all hotel System networks can be monitored. Even in the case that the hotel would like to get directly involved in the management of the System, it would be desirable to have a remote centralized location from which all of the hotel chain's System networks can be managed. A server can provide data to a remote management center using the Internet-standard SNMP or a variety of vendor-specific protocols. Since SNMP is an open-standard interface, it is considered the better choice for a remote management tool for the System. For a full list of the MIB objects in the Ethernet MIB (1.3.6.1.2.1.10.7) please refer to [5].

### System SNMP Extension Agent

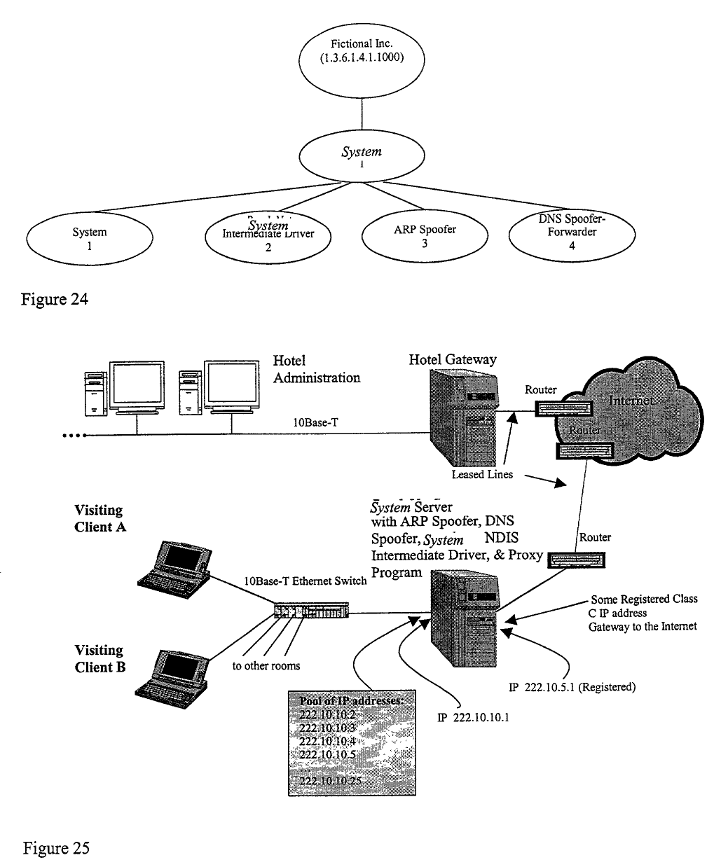

Each System server shall in addition have a full range of Ethernet statistics available provided that the Ethernet NIC used provides statistics to the SNMP agent service. Although the MIB objects supplied with the standard SNMP agent service are largely sufficient, there are several MIB objects which would be desirable for the remote administrators of a System service installation. The proposed proprietary MIB tree belonging to the company (let's call this company Fictional Inc. with a proprietary MIB identifier of 1000) which designs the System SNMP agent is shown in FIG. 24. The System SNMP Extension Agent MIB objects contained in this MIB tree are shown in Table 1. “Not Accessible (NA)” implies that this object is not directly accessible, but may contain one or more sub-objects which are directly accessible.

Note from Table 1 that this defines an algorithm to remove DestAddrPool entries using the TTL (see IntDestAddrPool in Table 1). If an entry is not found in DestAddrPool when a packet is received by the System NDIS Intermediate Driver from either the miniport driver or the protocol driver, then the packet must be discarded. Without this, if packets are received for a connection not represented in DestAddrPool, then the driver will crash. The only exception is if a SYN segment is received from the miniport driver with a source IP address and source TCP/UDP port not currently in DestAddrPool, since this tells the intermediate driver that a new connection is being requested.

Many MIB objects are indicated in Table 1 as Read/Write (R/W) access which allows a degree of remote control of the System service in addition to remote service monitoring. The additional difficulty of implementing R/W access as opposed to Ready Only (RO) access has not been assessed at the time of submission of this document. If deemed prohibitively difficult to implement, the access levels of these MIB objects may be changed to RO, and will be used for monitoring and statistics gathering purposes only.

In the Billing Section several options were presented to compute the charges incurred by the System client. SNMP could additionally be used as a method of conveying this billing information to the hotel administration. SNMP could also be used to track print jobs for charging purposes if the network printer software supports SNMP.

Finally, remote management capabilities through SNMP could also be included to monitor and possibly even initialize switchover to/from a redundant card as outlined in the Redundancy Section.

Thus far it has been shown how the System server can make information and a degree of control available to a remote network management center should such information be requested. However, the System server should also have a mechanism to notify the remote management center of any serious problems. Therefore, as part of the System Extension Agent, SNMP traps also need to be addressed.

The actual sending of trap messages is handled by the SNMP service extendible agent. However, the detection of trappable events, the collection of trap data, and the initiative to send traps originate from within the extension agents [36]. Microsoft's basic SNMP agent service already supports the generic SNMP traps specified by MIB-II [36]. In addition to these traps, one additional trap is recommended for the System Extension Agent. It is shown in Table 2.

Using a web-based management tool such as WMI may allow ease of access for an administrator within the hotel without requiring a special enterprise management platform.

Method for Direct Internet Access

This section proposes an architecture wherein the System server directly accesses the Internet, without the need of any gateway server. The System solution incorporates IP address translation into the System NDIS Intermediate Driver. A typical direct System access scenario is shown in FIG. 25.

In the previous discussion, the gateway server is required because the IP addresses of the visiting clients can be any value. Therefore a default route is required at the System server to direct packets towards the client-side adapter. A static route is then entered towards the gateway server, which works since all connections established by the proxy server are cascaded to the gateway server proxy program, a specific IP address. If direct access were allowed to the Internet from the System server, then the proxy program at the System server would need to establish a connection with the destination server specified by the visiting client. This destination server can have any IP address. Since it is not feasible (nor possible) to store a static route entry for every possible destination IP address or subnet in the OS's routing table, another default route would be required directing packets out the Internet-side adapter of the System server. Specifying two default routes in Windows NT (or any router) confuses the operating system and will not work.

To solve this problem, a pool of available IP addresses may be configured for use by the System server. Whenever the System NDIS Intermediate Driver receives a packet from a source IP that it has never seen before (or at least not seen recently), it allocates one of the IP addresses from its pre-configured IP address pool to this client and stores the actual IP address along with this new allocated IP address in DestAddrPool. On the return path, the System NDIS Intermediate Driver would do a lookup in the new DestAddrPool to see which actual source IP address corresponds to the destination IP address of the packet it is to send back to the client, and inserts this actual IP address of the client into the packet. The pool of IP addresses need not have any meaning on the Internet (not registered), since all packets actually sent out by the System server will have its registered IP address as the source IP address.

Using a pre-configured IP address pool solves the problem of requiring two default routes at the System server. An example best illustrates how the situation is improved. Table 3 is an example of what the routing table at the System server for the scenario depicted in FIG. 25 might look like. The default route is now set to the adapter that directly accesses the Internet. The routes for the IP addresses from the pre-configured pool are entered as static routes.

The advantage of this implementation is that it retains all of the service offerings of the System implementation discussed throughout this paper while minimizing the number of required network components. In fact, essentially considering the System server and the gateway server as a single network component in all previous sections allows the System developer to re-use all of the system design in this paper for this direct access architecture. Of course, the proxy program at the System server would no longer need to be configured to cascade proxy requests. Nor would a custom proxy program require a peer at the gateway server since the System server is also acting as the gateway server in this implementation.

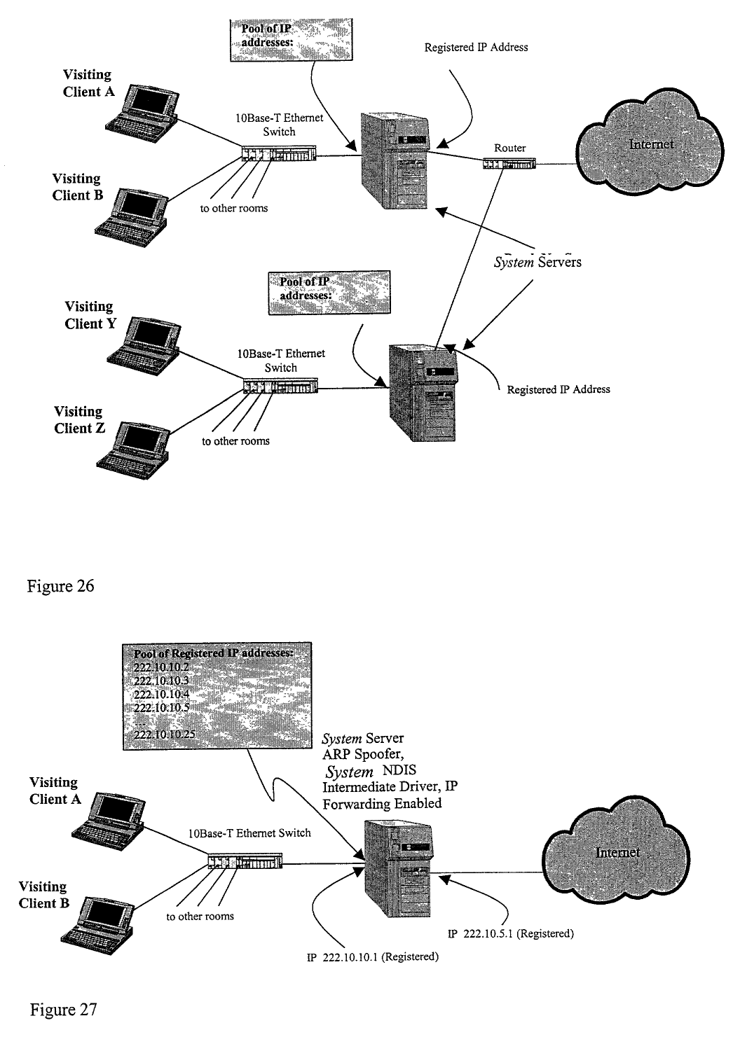

The System direct access solution also allows for scalability on the hospitality center's premises. A router can be used to connect many System servers to a high speed connection to the Internet. Since all IP packets destined for each System server will all only have one destination IP address, the routing table at the router would be very small. Note, however, that the capacity of each System server is limited by the size of the allocated IP address pool. No additional leased lines to the Internet are required if the hotel requires more capacity than one System server can handle. FIG. 26 illustrates a typical realization of a larger scale System solution using the direct Internet access approach.

One disadvantage of this solution is that each additional System server added to the hospitality center's premises requires at least one additional registered IP address (POP) to be purchased/leased. Another disadvantage is that some degree of security (i.e. a firewall) is required to be running on each System server in this scenario.

### IP Forwarding

Enabling IP forwarding on a computer essentially turns it into a router for all IP packets not addressed to it [2]. One alternate implementation of the System is to turn the System server into an IP forwarder which sends packets out onto the Internet. Consider the scenario illustrated in FIG. 27.

The inherent problem with this scenario is the routing. First, if the source IP addresses of the visiting clients are used as the source IP addresses of the packets sent out onto the Internet, then the packets on the return path will be routed back to the actual home networks of the visiting clients, not to the hotel. Also, there is the problem where the default routes in the routing table at the System server must be set to both network adapters at the same time since the visiting clients can have many different IP addresses and the desired destination servers can have many different IP addresses (recall the previous section).

The proxy program previously resolved the first problem. The proxy program set up an independent connection using the IP address of the gateway server as its source IP address. However, if we now use IP forwarding, the packets received by the System server will never reach any applications above the TCP/IP protocol stack and so a proxy program cannot be used. Instead, a pool of available registered IP addresses can be utilized. This IP address pool would be similar to the one proposed in the previous section, with the exception that all IP address must have meaning on the Internet, since routing needs to be done based on them. As before, whenever the System NDIS Intermediate Driver receives a packet from a source IP that it has never seen before, it allocates one of the IP addresses from its pre-configured IP address pool to this client and stores the actual IP address along with this new allocated IP address in DestAddrPool. The System NDIS Intermediate Driver in this case would not change the destination IP address of incoming IP packets to equal the client-side adapter of the System server since we want the packet to address the actual destination server. Instead it would simply change the source IP addresses of the packets to equal whichever IP address was allocated to that connection from the IP address pool. On the return path, the System NDIS Intermediate Driver would do a lookup in the new DestAddrPool to see which actual source IP address corresponds to the destination IP address of the packet it is to send back to the client, and inserts this actual IP address of the client into the packet. Also, in this case the send routine would not need to convert the source IP address of the packet sent to the client to equal the stored destination IP address for the connection. This is because the System NDIS Intermediate Driver does not change the destination IP address during the receive routine in this implementation, as just discussed. Using a registered IP address pool also solves the problem of requiring two default routes at the System server.

Note that this solution does not make use of either a proxy program or the DNS Spoofer at the System server. This is because everything is handled beneath the application layer. This imposes severe restrictions on the services offered to visiting users. For example, successful requests for destination servers using domain names instead of IP addresses are dependent on the DNS server configured for the visiting client being publicly accessible. If the DNS server that a client normally uses is on a secure private network, then name resolution will not work. A similar problem is encountered for the case where the client is configured to use a proxy. The solutions to these problems are non-trivial and would need careful consideration if this implementation alternative were chosen.

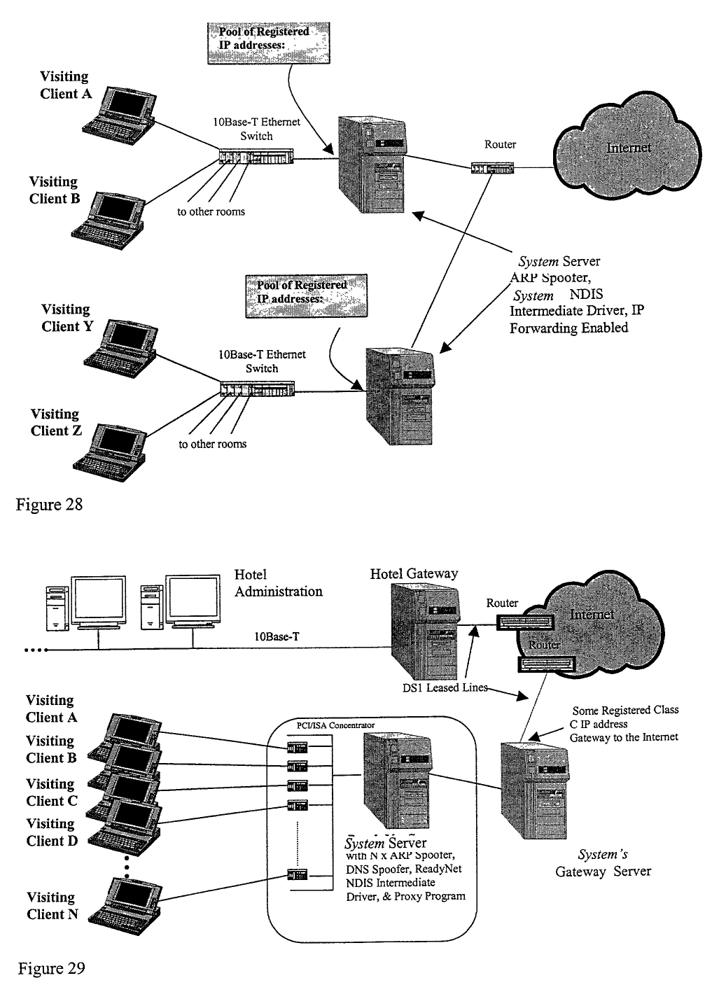

One advantage of this solution is that it does not sacrifice scalability, while reducing the infrastructure required at the hotel (i.e. only one server is required at a minimum). The solution can be scaled to meet the needs of a large hotel by simply adding System servers (essentially routers) to the existing infrastructure, as illustrated in FIG. 28. All that is required is an appropriate routing scheme and a pool of registered IP addresses at all of the servers that are directly connected to visiting clients. Note that the capacity of each System server is limited by the size of the allocated IP address pool. Also note that no additional leased lines to the Internet are required if the hotel requires more capacity than one System server can handle.

This alternate approach may warrant further consideration for the case where the target market is the non-corporate, non-proxy user. For instance, a high performance configuration-free mobile access service catered towards dial-up modem users may be provided by such architecture.

### Transparent Proxies

The most visible problem of classical application proxies is the need for proxy-capable client programs and/or user education so that users understand how to use these proxies. Some recent firewall products support a capability called “transparent proxying.” A transparent proxy allows users to take advantage of a proxy without having to change their procedures or re-configure their applications. This proxy method is accomplished using a form of IP address hiding similar to the one employed by the System server using the System NDIS Intermediate Driver in conjunction with the custom proxy program. It appears at first glance that this is just what we need to provide a building block for a service like the one proposed by the System. However, there are several limitations to a transparent proxy, as it is defined and implemented by most vendors [25].

First, the transparent proxy system must be able to address all client and server systems to which it may provide service. It must also know all IP addresses for which connections will be accepted and valid IP routes to all these client and server systems. Therefore, the proxy server must be pre-configured with the IP addresses of the clients that it services. Since in our case the clients will have constantly changing IP addresses, development would still be required to build a proprietary driver so that all clients would seem to have a valid IP address from the transparent proxy's point of view. This can be accomplished using the IP address pool introduced previously in this section.

Second, the transparent proxy is not typically designed to proxy requests which are intended to be proxied. Therefore, the exact opposite design problem is faced from the one we have seen with the System implementation, where we required development to handle non-proxy requests. If a transparent proxy would be used to design the System, development will be required to handle proxy requests.

The transparent proxy does have some attractive features already implemented that we would no longer have to handle ourselves. For instance, a transparent proxy must include some sort of DNS proxy mechanism similar to the one suggested by the DNS Spoofer-Forwarder. Also, the transparent proxy would already have a non-standard TCP/IP implementation that would allow the transparent proxy to masquerade as any destination server.

### Multiple Network Adapter System Implementation Method

A drastically different approach to the System solution would be for the System server to have one network adapter for each visiting client. This solution is reasonable considering the ever-decreasing cost of network adapters. However, some fundamental components of the System would require significant modifications.

In this scenario, the System server is connected to a PCI or ISA concentrator of network adapters. Such devices are readily available from hardware retailers. Most concentrator manufacturers have available models that support at least 16 slots per concentrator. The topology of such a network would look like the one shown in FIG. 29.

All of the network adapters in the PCI/ISA concentrator require a separate binding to the System NDIS Intermediate Driver. Each adapter would also need to retain its own DestAddrPool table. This table would only ever have one entry since only one computer is connected to each network adapter. The ARP Spoofer, since it can only listen on one network adapter, must have multiple processes running, one for each adapter. These multiple processes can set up dynamically, using threaded processes, or they can be kept running at all times, regardless of if a client is using the adapter it is associated with. Neither the DNS Spoofer nor the proxy program need to be modified for this configuration.

All IP datagrams to be sent to the clients must go through a specific interface card. The IP address pool concept introduced previously in this document can be used in a different way to accomplish this. Each network card would require one specific IP address to use as the source IP address of the client before the packet is sent on to the TCP/IP protocol stack in the OS. Then, static routes would need to be set up in the OS to route to certain network cards, using the IP addresses that the visiting clients are masquerading as to decide which card is appropriate.

This configuration does have significant advantages. It has inherent security, since the clients are physically separated from each other. Furthermore, it does not suffer from the duplicate IP broadcast domain problem discussed. Finally, billing is easier to manage since each hotel room can be associated with a specific network adapter.

Unfortunately, the solution becomes somewhat more expensive. Consider a very large hotel with a large number of rooms. Even if there is not much customer traffic, and one System server can support the throughput demands of all the guests, one Windows NT Server 4.0 OS will certainly not be able to support all of the network cards needed for every room in the hotel. The theoretical limit to the number of network adapters which Windows NT can support simultaneously is 10 (for a fully operational OS with no disk drives). This theoretical limit is introduced by the number of different Interrupt Request (IRQ) levels that Windows NT 4.0 supports. Currently, 16 IRQ levels are supported. With 6 IRQs allocated to only minimal system resources, the number of IRQs available to network adapters is 10. IRQ chaining can be used to increase this number, but this requires the purchase or development of specialized network adapters.

Finally, note that this configuration (recall FIG. 29) can be easily modified to allow the System server to be the direct interface to the Internet. This is due to the fact that this architecture makes use of the IP address pool, which allows routing coherency to be maintained.

### Evolution Flexibility

In this section the ability of the System to adapt to new platforms and technologies is examined. First, the effects of upgrading the System server platform to Windows NT Server 5.0 are discussed. Next, the impact of IPv6 on the System is introduced. Lastly, the ease with which the System can be evolved to support other LAN systems is touched upon.

### Supporting IPv6

The most important changes to IP version 4 in IP version 6 are:

IPv6 increases the IP address size from 32 bits to 128 bits, to support hierarchical addressing, to provide for a much larger number of addressable nodes, and to support simpler auto-configuration of addresses.

The addition of an “anycast” address and the addition of a “scope” field to multicast addresses.

Simplification of the header format to reduce the processing cost of packet handling and to limit the bandwidth cost of the IPv6 header.

Improved support for extensions and options in the IPv6 header.

Flow labeling for “real-time” service.

Authentication and privacy capabilities.

To support IPv6 over the System, first a TCP/IPv6 stack will need to be installed on the Windows NT server running the System. The changes to the System itself will be minor since the TCP/IP stack still does all of the protocol manipulation. The buffer pointers in all of the software components would need to be adjusted to account for the different IP header and the IP checksum calculation could be removed from the System NDIS Intermediate Driver and the DNS Spoofer (IPv6 headers do not include checksum fields).

However, IPv6 is still being tested. Once it is deployed, widespread use will be slow in coming. Until IPv6 support is necessary, the System will be able to support any IPv6 client since IPv6 is fully backward compatible with IPv4.

Wireless LANs

Wireless Ethernet LANs can be used to deliver Internet port connections, and the System could provide laptop access using wireless LAN cards. Since wireless Ethernet LANs use the same MAC scheme, only with a different physical transport mechanism. Therefore, the only change to the System server to support this type of LAN would be to the network card installed on the client-side of the Windows NT Server 4.0 machine running the System software.

### Non-Ethernet LANs

The configuration-free access concept is well demonstrated by the System. This concept can be extended to virtually any type of LAN. For example, Token Ring using the IEEE 802.5 MAC protocol makes use of a token which circulates in a LAN with a ring topology. When a station has data to transmit, it seizes the token and transmits on the LAN. The System server can be modified to spoof the destination host on a Token Ring LAN in a similar manner to an Ethernet LAN since it uses a similar shared medium addressing scheme. However, significant modifications to the System NDIS Intermediate Driver and the ARP Spoofer would be required. This is as expected since these two programs are highly dependent on the supported MAC protocol. Note that no modifications would be needed for any LAN using TCP/IP to the DNS Spoofer or proxy program, since operation of these two components is above the Layer 2.

The argument for Token Ring can be extended to other technologies. Protocol specific development will be required in all cases, but cases for the support of FDDI, which is very similar to Token Ring, and 100VG-ANYLAN, which is very similar to 100Base-T but including a demand priority scheme, can be made as well.

### Windows NT 5.0

The most significant changes in the Windows NT architecture between version 4.0 and 5.0 is the active directory and the use of DNS for name resolution. The active directory extends the Windows NT Server 4.0 directory into a fully extensible, scalable directory service that can meet the needs of corporate intranets. Version 4.0 and earlier versions of Windows NT Server depend on NetBIOS names (i.e. NetBEUI names) and have implemented the Windows Internet Name Service (WINS) to resolve computer names to IP addresses. With Windows NT Server version 5.0, DNS is introduced as the name resolution mechanism. Neither of these two changes should impact the System's service offering to the end user, since the System's clients do not either use the server for file sharing or communicate directly with the server through name services or otherwise.

NDIS is enhanced somewhat in Windows NT Server 5.0. However, all Windows NT 4.0 network drivers are backwards compatible on the Windows NT Server 5.0 platform [12].

### Embedded System

From a marketing standpoint, a fully embedded System could be very attractive to a hotel or conference center. In this implementation, once a final version of the System is available, the entire working version, complete with a full OS, can be uploaded onto a device such as the DiskOnChip 2000 FlashDisk device. The DiskOnChip 2000 would reside in a small housing with two network adapters, one for the client-side network, and one for connectivity to the gateway server. An embedded system would make tampering with the System less likely and make the product less obtrusive to the hotel. This small box could be placed in a wiring closet on every floor of a hotel, from which it would be connected to the gateway server in the basement.

### Supporting Mobile IP

It is possible to support the Mobile IP protocol over the System. Mobile IP essentially only specifies a registration method with the mobile client's home agent. Therefore, at the System server, a custom Mobile IP agent would be required to be developed which would periodically poll the System client network with Agent Advertisement messages. If a mobile node is present on the network, then the mobile node would use the IP address contained in the Agent Advertisement message as its foreign “care-of” IP address. The mobile node would then try to register with its home agent using a Registration Request message. At this point, the System server's Mobile IP agent would respond with a spoofed Registration Reply which would fool the visiting client into thinking that registration with the home agent was successful. The connection procedure with any destination server through the System server would then continue like for any other visiting client on the System client network. Note that this solution is possible only because IP packets are sent out in the normal fashion from the client machine, and are received in a normal fashion, so long as the mobile node does not use a co-located “care-of” IP address. That is, under normal circumstances, the IP tunnelling is transparent to a mobile client using Mobile IP. This allows us to relax the restriction put forth that the visiting client does not run Mobile IP.

### Hardware Implementation of the System

An alternate solution for the System would be a hardware solution. Of course, a total redesign of the System would be required. Obviously, the entire Windows NT Server 4.0 OS is not going to be implemented in hardware. Enhanced performance would be expected in such an implementation. However, new versions and bug fixes would be much more difficult to deploy.

### Cable Modems

The use of cable modems as a configuration-free Internet access method from hotel rooms is very attractive to hotel proprietors. After all, most hotels have extensive wiring of coaxial cable for CATV signal distribution. The support for cable modems on the System has been tested as well as DSL. These are trivial extensions.

### DESCRIPTION OF A PREFERRED EMBODIMENT

### Windows NT

The System has been developed as a Proof-of-Concept for a software-based network service that allows client computers access to IP services without modifying their current IP configuration or the need to install any software or hardware to accommodate this. The development of this service was done in two separate components to operate on a Microsoft Windows NT 4.0 system (with Service Pack 3 or 4 installed). One component is an Intermediate Driver that is configured to reside between the physical adapter driver and the IP stack. The driver was written in C and was an addition to an Intermediate driver sample (IMSAMP) supplied with the Windows NT Driver Development Kit (DDK). The other System component is a user-level application that deals with the proxying of the various IP services. The application was written in C++ under the Visual C++ environment and was wholly original code.

A detailed description of these components follows, with particular attention to the implementation of the algorithmic components of the System. This implementation provides the functionality of the System as described in earlier sections. Depending on the particular hardware and/or OS that the System is to operate on, this implementation would vary. A full formal description of the System can be found Appendix A. This provides flowcharts and source code to give a more detailed description of this implementation.

### System Intermediate Driver

As stated earlier, the System driver prototype is an addition to the Intermediate Sample Driver provided in the Windows NT DDK (IMSAMP). The language used is C, and the build environment used is one supplied with the DDK. The following sections describe the System-specific additions to IMSAMP.

The driver provides several low-level functions that must be handled before the System client packets are allowed to come from the adapter driver to the Windows NT TCP/IP stack. There is also address mapping that has to be performed on packets coming in from the server-side destined for System clients. These functions are handled by code in recv.c and send.c, respectively. There are also some housekeeping duties that have to be performed on the mapping table (table.c) which are handled by timer.c.

To store low-level information about each client connection, a table (DestAddrPool) is constructed containing fields for the source IP address, the destination IP address, the source MAC (physical) address, the source port, and a ‘time to live’ (TTL). Functions are designed to add all this information to the first available empty spot in the table (TblAddEntry) and to retrieve the information contained within a particular table entry (TblGetEntry) given a source IP address and a source port.

The fields in the table were chosen to provide a specific mapping of an IP socket (IP address and port number) to a MAC address. The idea here is that when a client initiates a connection to some other IP address, any data coming back to it can be directed to the proper computer by knowing where the data came from and what port it was going to. A source IP address and MAC address can be retrieved from that information and the IP packet properly addressed and sent to the appropriate System client. This particular implementation also uses a hashing function based on source IP and source port to determine which table row to store and/or retrieve from.

Both the destination IP and port numbers are used, as it is unlikely that two computers will be communicating with the same IP address on the same source port. The MAC address is included in the client information for two reasons:

1) The MAC address should uniquely identify the client. Two computers may have the same IP address (this can be common as private IP addresses are commonly used in corporate Intranets), but it is far less likely that they have the same MAC address as these should be unique to a particular network adapter. By using the MAC address, redundant entries in the table due to identical IP addresses are removed.

2) Since the MAC address can be used to uniquely identify the client, it should be possible to use this for any kind of special features that would be incorporated into a production version of the System such as billing, advertising, and enabling of services.

There is a hard limit of 101 entries in the table. This can be changed to another prime number (due to the hashing function) to increase this. Another option is to dynamically allocate memory to expand or reduce the table to meet the client demand.

The code contained within this source file deals with decreasing the TTL value for each table entry and checking to see if any have expired. This is done with the function CheckTimeouts.

The reason for this is to clear the table of any entries that are no longer needed. It is expected that each client will only be using System services for a short time, a few hours at the most, so the finite table should be cleaned up whenever possible. The TTL field is refreshed whenever it determined the connection persists (outside timer.c) but when not refreshed periodically, CheckTimeouts will erase these entries after some time (currently specified as 5 minutes for TCP connections and 1 minutes for UDP entries).

This code deals with receiving IP packets from any System clients and dealing with them appropriately. There are two main activities that are taken care of by recv.c. The first is the packaging of packet source and destination information into a UDP packet (a System packet) to be sent to the proxy application (on port 60). The second is the modification of this same information in the original packet to allow the Windows NT TCP/IP stack to deal with it appropriately and pass it on to the proxy application. Thus, for each IP packet two packets are sent up the stack. One contains the original addressing information from the client, and the other contains the data from the client. Both are addressed to the proxy application.

The only times a System UDP packet is created is when the packet received is a UDP packet and when the packet received has the TCP synch and/or fin flags set. For TCP, this information is only required to set up the connection (handled by the proxy application) and is thus not required for every packet.

The System packet is constructed as follows:

Copy the original destination IP address into the data portion of the new UDP packet.

Set the fin flag.

Copy the source IP from the original packet.

Copy the source port.

Set the destination IP to point to the address of the client-side card (192.168.5.1).

Set the protocol field to be UDP.

Set the UDP length field to contain the data size.

Set the total length field in the IP header.

Set the destination port number to be set to the port the custom proxy handler listens to (60).

Recalculate checksums.

Pass the buffer up to the transport layer (TCP/IP stack).

In re-constructing the actual client packet, the following occurs:

The appropriate information is added to the MAC table (DestAddrPool) if it is a UDP packet or if it a TCP packet with the sync flag set.

Remove the table entry is either a reset flag is set, or if a fin flag is detected.

If the packet is determined to be part of a non-proxied (i.e. Direct connection) session, the destination port number is changed by adding RN_PORT_OFFSET (currently 10,000). The proxy application will be listening on this port for non-proxied connections.

Change the IP destination address to that of the System client-side adapter (192.168.5.1).

Recalculate the IP and TCP/UDP checksums.

Send the packet up to the transport layer (TCP/IP stack).

Proxied requests are detected by simple guesswork. If a packet is addressed to the System client-side adapter (192.168.5.1) it is extremely unlikely that this would be an address a client would use in its regular communications. However, due to activities performed by the proxy application, any DNS queries that are unresolvable are responded to with the client-side adapter address (192.168.5.1). This is typically for local names, such as what is generally used in configuration to use a proxy. Thus, any packet addressed to 192.168.5.1 is considered to be a proxied communication.

The send.c routine deals with sending packets to the System clients. When a packet arrives to the send routine, it is checked if it is an IP packet. If so, the information from the DestAddrTable is read based on the source IP address (presumably the destination IP address from the System client's point of view) and the destination port. If the table entry is not found, either the client did not establish the connection or the connection timed out (by the timer routine in timer.c). In either case the packet is discarded. If the table entry is found,

The TTL counter for that entry in DestAddrPool is refreshed.

From the table, the original destination IP replaces the one in the packet (the System server-side IP address).

The source MAC address in DestAddrPool replaces the destination MAC address currently in the Ethernet frame.

The table entry is set to clear if a fin flag accompanies the packet.

If the packet is from a non-proxied communication, the source port is changed to the original port number (by subtracting RN_PORT_OFFSET).

Checksums are re-computed.

Packet is sent on its way.

### System Application

A Windows NT 4.0 application is the user-level component developed in the Microsoft Visual C++ development environment. The primary purpose here is to handle any IP packets coming from or going to System clients. This code is much more expansive than that of the driver

### Main Process

Main.c contains the source for proxy.exe. This code does two things:

1) Reads configuration information from the rnetconf.txt file. There are 5 parameters that are checked for:

LOG_MESSAGE_LEVEL that determines the level of detail of messages appearing on the System console.

RNET_DNS_INET_ADDR which is the address of the DNS server to be used by the System server.

RNET_SERVER_INET_ADDR is the address of the Internet-side adapter on the System server.

ADAPTERNAME is the device name for the client-side adapter that Windows NT uses to communicate with it.

MACADDRESS is the Ethernet address of the client-side adapter (the MAC address).

2) Starts the System services by calling LaunchServices (found in Service_Manager.cpp). ServiceManager.cpp contains functions that deal with the various services supported by the System. These services are listed in ThreadMtceTable that lists the service, the state, number of errors, and the function that handles the thread (which is found in handlers.cpp). LaunchServices goes through ThreadMtceTable and for each service, starts its handler as a separate thread (using StartThread).

Every second, LaunchServices also checks to see that each of these threads is still running, and if not, it attempts to start that service again.

### ARP Spoofer

The ARPSpoofer service is started from LaunchServices. Arpspoof.cpp contains the code for this in the function RnetArpSpoofer. There is also a shutdown procedure names RnetArpShutdown that closes the packet driver that the ARP spoofer uses. For this implementation of the ARP spoofer, the Microsoft packet driver must be installed (this is included in the Platform SDK). What the packet driver provides is the ability to set the physical adapter to promiscuous mode, and to retrieve the low-level Ethernet packet and send it to a user-level application. Packets can also be constructed and sent back to the packet driver who will then be sent to the adapter.

RnetArpSpoofer opens the client-side adapter (from the MACADDRESS and DEVICENAME fields in rnetconf.txt) and begins monitoring for incoming packets. Any packets that are determined to be ARP requests that did not come from the client-side adapter are acted upon. The ARP spoofer will respond to any ARP requests with it's own MAC address. In this way, it will appear to be all computers to any clients. A client will send out ARP requests for any IP address on its subnet that it wishes to send data to. That machine would normally respond with its MAC address and thus the querying machine would be address Ethernet packets to it. The System attempts to appear as any computer to its clients, typically the clients' gateways, proxy servers, and/or DNS servers.

When an ARP request is detected, the IP routing table of the System server is modified. A route is created directing any IP traffic to the client's IP address by way of the System client-side adapter. Creating a new process that executes the ‘route’ command with the appropriate parameters modifies the route table. It is assumed that if the IP address in use is a client-side IP, no other clients will be attempting to communicate with the same IP address on the server-side of the System server. That IP address is either private, in which case clients would not be typically communicating with it, or the address is public, in which case since it is mobile it is likely not an interesting server that the clients would typically be communicating with.

After the route is added, an ARP response is created that indicates the client-side MAC address. Any exceptions (typically shutdown procedures) will cause the RnetArpShutdown function to be called.

Some housekeeping duties are required here to clean up the route table when entries are no longer in use. An internal table is present with the connections listed along with the last time an ARP request came from that IP address. After a period of inactivity, is safe to delete the appropriate route from the IP routing table (and the internal table). Clients typically clear their own ARP tables every few minutes and must send out new ARP requests for IP addresses that they wish to communicate with. This will refresh the

### DNS Proxy/Spoofer

As the name suggests, the DNS Proxy/Spoofer performs two main activities:

1) Transparently proxies DNS requests to the System server's DNS server. Responses are sent back to clients (if the response is valid).

2) Spoofs DNS requests that are not resolved with its own IP address. This is done because DNS requests that cannot be resolved are either unresolvable (not registered names), or are for local names such as proxies or local servers. These will be unresolvable from the remote location in any event, but the client machine should believe the System server is any local server that it is wishing to communicate with.

The Proxy/Spoofer is started by the LaunchServices command. It monitors a specific IP port as DNS requests are conducted on port 53 [RFC1700]. Any packets arriving on that port are first checked for as coming from the System server. If not, the names are checked for any periods. Names without periods are assumed to be local and these are automatically spoofed.

DNS questions coming from System clients (if they have periods) are forwarded to the System server's DNS server (whose IP address is determined by the value of RNET_DNS_INET_ADDR in rnetconf.txt) immediately. Information about the request is stored in a table (DNSTable . . . see DNSTable.h for the source code). This information includes the domain name (DomainName), the sources IP address (SourceIP), and the DNS transaction ID (TranslD). There are also routines for retrieving the IP address of the source from the DNS table based on the domain name and transaction ID, or the domain name and source IP address.

DNS answers received from a DNS server are sent to clients after their IP address is looked up in DNSTable. For several cases, the answer returned will be the IP address of the System server's client-side IP address. These cases are:

1. There is no ‘.’ in the domain name.

2. The return code (from the DNS server) is equal to 3 (the name was NOT found).

3. The response timeout is exceeded (currently 10 seconds).

### Protocol Handlers

Each proxied protocol has a handler function (or functions) associated with it. The prototypes of these are found in handlers.h and the functions themselves are found in handlers.cpp. Each handler monitors a particular client-side port determined by [RFC1700]. These are defined in globals.h. The handlers are listed in Service_manager.cpp in ThreadMtceTable with a text name and the name of the handler function.

CONN_TBL stores information about each connection based on the source port (src_port), source IP address (IP), and destination IP address (dst_ip). The time each entry is inserted into the table is also included, as well as whether or not the particular client had seen a splash screen in his/her current session.

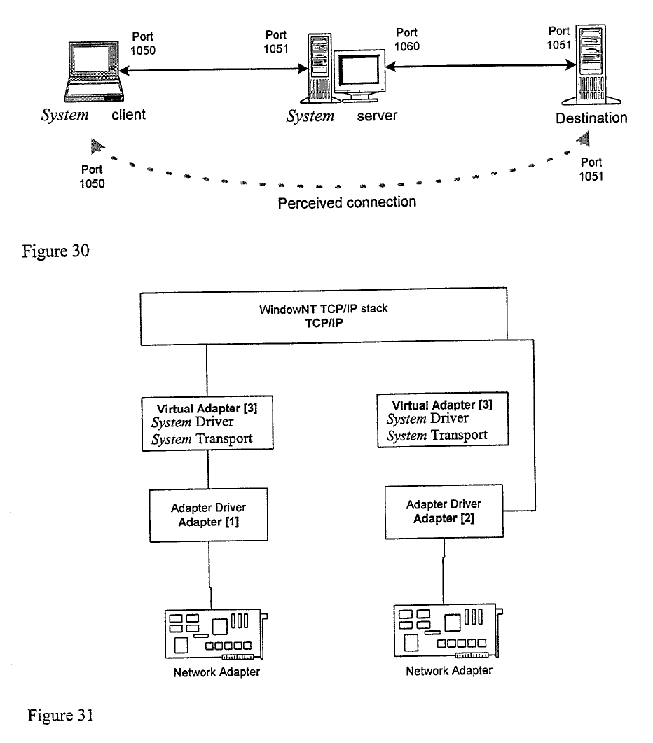

Each handler is started by listening to the appropriate port (plus an offset as described earlier) on the client-side adapter. Any traffic on the client network with the appropriate destination port will be received and processed according to the particular protocol handler function. A socket will be created for each such connection. For example, an HTTP handler is associated with any TCP traffic destined for port 80. This processing takes the form of opening a socket on the server-side to the desired destination on some ephemeral port. The source port is not required to be the same as the client's source port (in general). The IP packet is modified accordingly (change in source IP address and source port) and sent off to the appropriate destination via the server-side adapter. The source and destination IP addresses, along with the source port are stored in a table conn_tbl_tp in tables.h. When packets arriving from this destination are processed, the source IP and source port can be determined and sent to the appropriate client. In this way, the System acts as a network address translator with port mapping (NAPT). An example is shown in FIG. 30.

Two main activities lead to the need to clean up the tables that the System uses to store connection and client information. The first is that clients are typically temporary. They will remain connected to the System service for some period of time and then leave to go to a new location or to their regular location. With a client no longer present on the System, information regarding that client and its past connections need not be remembered. Another reason to clean up the tables is that with a large number of clients connecting to several locations using a variety of IP services, the resources used by the tables can get too large to be very efficient.

Each table has a timer associated with it that occasionally checks each table entry to check for expiry. Each entry will have a timestamp field that will either be reduced with each check, or will be compared against the current time. Old entries that are past their time to live, or have expired are cleared.

### System Logger

Contained within the source code, each event has a text string associated with it along with some appropriate variable values that can be printed via a logger function and sent to the terminal screen. Each event has a priority value associated with it, with smaller numbers being higher priority. Depending on the value of Log_Message_Level contained in RNETCONF.TXT, messages associated with these events may be displayed if the value specified is less than or equal to the priority of the message. Thus, with a low setting for Log_Message_{'}Level, only the most important events will be displayed. A mutex protects the logger function so only one thread can access it at a time.

### System Bindings Under Windows NT

In order to configure the various components that comprise the System to run under NT, the bindings between network adapters, network services, protocols, and System components must be set up correctly.

System services only deal with traffic coming from and going to the client-side adapter. Also, the System driver must intercept traffic before the NT TCP/IP stack processes it. Upon intercepting the traffic, modifications are made to the header information as discussed earlier in this document so the NT TCP/IP stack does not discard the packets due to the network address being likely inappropriate. Thus, the System must be bound to the adapter and TCP/IP bound to the System on the client-side. On the Internet-side, all System services must be disabled. FIG. 31 provides a pictorial representation of this (bold type denotes items bound to the item below or above text depending on location).

### LINUX

### Readynet.c

The System needs two network adapter cards. One serves as client-side at which the clients reside and the other one serves as server-side, which connects to the external Internet. Normally, the packets received form both cards are sharing the same TCP/IP stack. However, in the System, the packets coming through two cards are treated differently. In order to identify which adapter card each packet coming through, a function readynet.c with a header file if_readynet.h are created.

In if_readynet.h, two variables are defined. READYNET_MAC_{'}ADDR is defined as the MAC address of the System client-side adapter card and READYNET_IP_ADDR is client-side IP address. The function if_readynet.h is localled in directory: /usr/src/linux/include/linux.

The function readynet_client exams whether a packet is received from the System client-side by comparing client-side MAC address READYNET_MAC_ADDR to the device hardware address of the skb_buff->device->dev_addr. Readynet.c is localled in the directory: /usr/src/linux/net/ipv4. In order to compile readynet.c into the kernel, the dependence of /usr/src/linux/net/ipv4/Makefile has to be modified by add the object file readynet.o.

### ARP

The System server tries to act like a gateway to every client. It accepts all ARP requests coming through client-side network and responses with its client-side MAC address. All ARP request are received in the routine arp_rcv and are handled accordingly. In order to assure that the modified arp_rcv routine only works for ARP request detected from client_side network, function readynet_client is used here.

### Arp.c

The routine arp_send is responsible for constructing and sending an ARP response to the ethernet level. Arp_send and all Ethernet level sending routines are handled properly. No modification is necessary. ARP table is updated after ARP response. The ARP requests need to let the System server know that the client that initiated the ARP request is on the client-side network. Modifying its route table manually can do this.

### Routing

Each route cache entries are stored in one structure called rtable which is located in the field of the hash table called rt_hash_table [symbol] . The index is calculated form the destination address by using a function: rt_hash_code(daddr, saddrˆ (iif<<5), tos). Manually add or delete a route entry through Linux kernel can be approached in two different ways. The first approach is to call a function ip_route_input, which calls another function ip_route_input_slow. If the destination and source address provided is valid, it creates a new structure rtable and adds it to the rt_hash_table. The process of checking validation of the destination or source address is very complicated. The second approach is to use system calls to execute a command line instruction from the kernel. The system call do_fork is defined in the kernel to start a new process. This is done by creating an identical copy of the process that has called do_fork (unsigned long clone_flags, unsigned long usp, struct pt_regs *regs). The system call do_execve(char * filename, char ** argv, char ** envp, struct pt_regs * regs) enables a process to change its executing program. Variables argv and envp are defined as array of strings. For example to execute a command line instruction: “route add 222.222.222.222 eth0”, variables argv and envp should be defined as follows:

```
    char *argv [] = {“sbin/route”, “add”, “222.222.222.222”, “eth0”, NULL};
    char  *  envp[] = { “HOME=/”,  “TERM=linux”,
“PATH=/sbin:/usr/sbin:/bin:/usr/bin”, NULL };
```

### IP Addresses

The purpose of the System driver is to replace the destination IP of the incoming IP packet with the IP of the client side System adapter IP address. This involves the direct modification of IP I/O. In file ip_input.c, the routine ip_rcv handles all the IP receiving.

### IP input.c

The skb_buff passed in this routine contains information of one of the IP packets in the IP incoming queue. The System need to redirect this packet to the System server-side and the server-side network adapter card will receive this packet normally. The idea of achieving this is to copy the information of this IP packet to a new buff called newskb by using the routing skb_copy. Modify the destination address of the IP header to the server-side System IP address. Re-calculate the IP checksum. Append this modified newskb to the outgoing queue of the IP sending routine.

An APPENDIX is attached hereto which includes basic NT source code and flowcharts for System algorithms. Not all of the source code is included, and in several cases some is removed for simplification. It is arranged by file, with procedures separated and flowcharts following. Global declarations are not included to reduce confusion, redundancy, and space.

The following code modules are included in the APPENDIX:

System application components

main.cpp

handlers.cpp

arpspoof.cpp

dnsproxy.cpp

System driver components

send.c

recv.c

Other components are functions that support the routines found in the above files or housekeeping functions. The driver routines are embedded within existing sample code after the incoming or outgoing packets are presented in an easily accessible manner. ARPSpoofer routines use the Windows NT packet driver to retrieve copies of incoming Ethernet packets and to create and send Ethernet packets.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

TABLE 1

| | | | |
|---|---|---|---|
| Object Name | OID | Access | Description |

System Parameters 1.3.6.1.4.1.1000.1.1

| | | | |
|---|---|---|---|
| SysVersion | 1 | Read | The major and minor version number of the |
| | | Only | installed System software, including the version |
| | | (RO) | of the custom proxy program at the gateway |
| | | | server if applicable (so that a new SNMP |
| | | | extension agent is not also required at the |
| | | | gateway server). |
| SysMaxNoClients | 2 | Read/ | The number of hotel rooms connected to this |
| | | Write | System server. |
| | | (R/W) | |

System Intermediate Driver Parameters 1.3.6.1.4.1.1000.1.2

| | | | |
|---|---|---|---|
| IntIPAddr | 1 | R/W | The client-side network adapter's IP address |
| | | | (this is the IP address all destination IP |
| | | | addresses are changed into when an IP packet is |
| | | | received). |
| IntDestAddrPool | 2 | Not | A table of IntDestAddrPoolEntry's. Each |
| | | Accessi- | IntDestAddrPoolEntry shall contain the source |
| | | ble | IP (RO), the source port (RO), the destination |
| | | (NA) | IP (RO), the flags (RO), the source MAC |
| | | | address (RO) and the TTL value (R/W). The |
| | | | TTL value shall be used to remove entries from |
| | | | the table (i.e. by setting the value to 0). |
| IntMaxConn | 3 | R/W | The size of DestAddrPool, which determines |
| | | | the number of connections which can be |
| | | | supported over the server. |

ARP Spoofer Parameters 1.3.6.1.4.1.1000.1.3

| | | | |
|---|---|---|---|
| ArpHardwareID | 1 | R/W | A string specifying the Ethernet card to listen |
| | | | on. |
| ArpHardwareAddr | 2 | R/W | The Ethernet address of the client-side network |
| | | | adapter of the System server. |

DNS Spoofer-Forwarder Parameters 1.3.6.1.4.1.1000.1.4

| | | | |
|---|---|---|---|
| DNSRetIPAddr | 1 | R/W | The client-side network adapter's IP address. |
| | | | This value is returned in response to DNS |
| | | | queries intercepted by the System server. |
| DNSDomNameTable | 2 | NA | A table of DNSDomNameEntry's. Each |
| | | | DNSDomNameEntry shall contain the domain |
| | | | name (RO), destination IP (RO) and |
| | | | corresponding table of source IPs (RO). |

TABLE 2

| | | Generic | Specific | | |
|---|---|---|---|---|---|
| | | Trap | Trap | | |
| Trap Name | Enterprise ID | Number | Number | Variables | Description |
| DestAddrPool | 1.3.6.1.4.1. | 6 (always 6 | 1 | IntMaxConn, | This trap is sent |
| Full | 1000.1 | for | | SysMaxNoClien | whenever |
| | (iso.org.dod.i | enterprise- | | ts, unique trap | DestAddrPool |
| | nternet.private | specific | | ID (always | attempts to store |
| | .enterprises.fi | traps) | | generated for the | n + 1 entries, |
| | cotional.ready | | | Trap PDU | where n is equal |
| | net) | | | header), time | to the maximum |
| | | | | stamp (always | size of the table. |
| | | | | collected for the | |
| | | | | Trap PDU | |
| | | | | header) | |

TABLE 3
Active Routes

| Network | | | |
|---|---|---|---|
| Destination | Netmask | Gateway | Interface |
| 0.0.0.0 | 0.0.0.0 | 200.10.5.1 | 200.10.5.1 |
| 222.10.10.2 | 255.255.255.255 | 200.10.10.1 | 200.10.10.1 |
| 222.10.10.3 | 255.255.255.255 | 200.10.10.1 | 200.10.10.1 |
| . . . | . . . | . . . | . . . |
| 200.10.10.24 | 255.255.255.255 | 200.10.10.1 | 200.10.10.1 |
| 200.10.10.25 | 255.255.255.255 | 200.10.15.120 | 200.10.15.120 |

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. Apparatus for connecting a portable computer to a remote site for data communication therebetween comprising:
a LAN having a plurality of connection ports each for receiving connection to a portable computer for data communication between the LAN and the portable computer;
the LAN having a predetermined domain identifier for identification of computers connected to the LAN;
a communication computer;
the communication computer having a LAN connection connected to the LAN for communication of data between the LAN and the communication computer;
the communication computer having a network connection for connection to the remote site for communication of data between the communication computer and the remote site;
the communication computer having designated IP address for use in communication with the remote site;
the communication computer being programmed to be responsive to messages using the predetermined domain identifier to receive a data transmission transmitted from a respective one of a plurality of computers connected to the LAN, to communicate the data transmission to the remote site using the designated IP address, to receive response data from the remote site and to transmit the response data to the respective computer;
the communication computer being further programmed to be responsive to messages using a domain identifier different from the predetermined domain identifier from a portable computer alien to the LAN to receive a data transmission transmitted from the portable computer when connected to the LAN, to communicate the data transmission to the remote site using the designated IP address, to receive response data from the remote site and to transmit the response data to the portable computer;
the communication computer being further programmed to be responsive to an ARP request message using a domain identifier different from the predetermined domain identifier from a portable computer alien to the LAN, which ARP request message requests identification of the MAC-address of a component of the LAN, to respond providing the MAC-address of the communication computer.

2. The apparatus according to claim 1 wherein, when the ARP request message from the portable computer is a request to identify a PROXY server of the LAN, the communication computer is programmed to respond providing the MAC-address of the communication computer.

3. The apparatus according to claim 1 wherein when the ARP request message from the portable computer is a DNS request which may be a PROXY request or a NON-PROXY request, the communication computer is programmed:
a) to receive and process the message,
b) to attempt to make a determination if the request is a PROXY DNS request or a NON-PROXY request,
c) in the event that the request is determined to be a NON-PROXY DNS request, to transmit the message to a DNS server to obtain a DNS IP address,
d) in the event that the DNS server provides a valid IP address, to communicate to the portable computer the valid IP address,
e) in the event that the DNS server provides no valid address OR in the event that the request is determined to be a PROXY DNS request, to provide to the portable computer the MAC-address of the communication computer.

4. The apparatus according to claim 3 wherein the attempt to determine if the request is a PROXY DNS request or a NON-PROXY request is done by the presence of a dot in the http request.

5. The apparatus according to claim 1 wherein the communication computer is further programmed, when transmitting the response data to the portable computer to maintain a table indicative of a port of the portable computer on which the response data is to be transmitted.

6. The apparatus according to claim 1 wherein the communication computer is configured in an architecture to handle duplicate IP addresses from different clients which have similar TCP/IP parameters by creating a routing table that includes a MAC-address entry for each client and/or by isolating clients in separate subnets; or mapping them to an IP address pool including their MAC-address.

7. The apparatus according to claim 1 wherein, when the ARP request message from the portable computer is a request to identify a PRINTER server of the LAN, the communication computer is programmed to respond providing the MAC-address of the communication computer and handle the printing job for the client by passing the printing job to a printer server within or by forwarding it to a printer server in the LAN and wherein the apparatus further provides printers in the client-side LAN that the client compute can utilize for printing as a standard service with minimal configuration within the standard OS functions and drivers.

8. The apparatus according to claim 1 wherein, when the ARP request message from the portable computer is a request to identify a EMAIL SEND server of the LAN, the communication computer is programmed to respond providing the MAC-address of the communication computer and handles the email as required by forwarding the message to a LAN email-send program or to an email system within the apparatus.

9. The apparatus according to claim 1 wherein, when the ARP request message from the portable computer is a request to identify a EMAIL RECEIVE server of the LAN, the communication computer is programmed to respond providing the MAC-address of the communication computer and retrieves the required email from a remote email server outside any firewalls and presents all retrieved email to the client computer.

10. The apparatus according to claim 1 wherein the communication computer is further programmed to be responsive to an ARP request message using a domain identifier different from the predetermined domain identifier from a portable computer alien to the LAN, which ARP request message requests identification of the MAC-address of a DOMAIN NAME SERVER, , a GATEWAY SERVER, a PROXY SERVER or an EMAIL SERVER or OTHER SERVICES of the LAN, to respond providing the MAC-address of the communication computer.

11. The apparatus according to claim 1 wherein the communication computer includes for connection to the LAN a network card and a driver for the network card and is programmed with a series of levels of program including an Internet Protocol program, an Applications program and a Gateway/Proxy program, the Internet Protocol Program being arranged to process only messages directed to the LAN and wherein the communications computer is programmed:
a) to receive messages from the portable computer at the network card connected to the LAN,
b) to translate messages which are addressed to an address alien to the LAN so as to re-address the messages to be processed by the Internet Protocol program for communication to the Applications program,
c) to communicate with the re-addressed message the original alien address for re-connection to the message.

12. The apparatus according to claim 11 wherein the communications computer is programmed:
a) to communicate the original alien address by generating a supplementary message for communication to the Internet Protocol program which includes the original alien address,
b) to recombine the re-addressed message with the supplementary message at the Applications program
c) to maintain a table identifying the portable computer and the alien address.

13. The apparatus according to claim 11 wherein the communications computer is programmed:
a) to balance the load on the network by utilizing a redundant apparatus,
b) to forward requests from portable computers to systems within for processing or systems within the LAN.

14. The apparatus according to claim 1 wherein the communications computer is programmed to:
a) protect packets from client computers from being seen by other client computers,
b) enabling VPNs services by handling CRC checksums and protocols.

15. The apparatus according to claim 11 wherein the communications computer is programmed to:
a) protect packets from client computers from being seen by other client computers,
b) enabling VPNs services by handling CRC checksums and protocols.

16. The apparatus according to claim 1 wherein the communication computer is further programmed:
a) to be responsive to the ARP request message using a domain identifier different from the predetermined domain identifier from the portable computer alien to the LAN to provide to the portable computer data defining a page to be displayed on the portable computer, the page being arranged to require entry of a private “key” provided to the user of the portable computer only,
b) to receive the private “key” when entered,
c) to maintain a record correlating the key with the MAC-address of the portable computer,
d) to generate a billing record indicative of times of usage of the LAN by the portable computer identified by the recorded MAC-address.

17. The apparatus according to claim 1 wherein the communication computer is further programmed to be responsive to a web page request message using a domain identifier different from the predetermined domain identifier from the portable computer alien to the LAN to provide to the portable the requested web page when obtained and to add to the web page so provided an “in-house” start web page specified by the service provider and - generated or retrieved by the communication computer.

18. Apparatus for connecting a portable computer to a LAN for which the portable computer is not configured comprising:
a LAN having a plurality of connection ports each for receiving connection to a portable computer for data communication between the LAN and the portable computer;
the LAN having a predetermined domain identifier for identification of computers connected to the LAN;
a communication computer;
the communication computer having a LAN connection connected to the LAN for communication of data between the LAN and the communication computer;
the communication computer being programmed to be responsive to messages using the predetermined domain identifier to receive a data transmission transmitted from a respective one of a plurality of computers connected to the LAN;
the communication computer being further programmed:
a) to be responsive to messages using a domain identifier different from the predetermined domain identifier from a portable computer alien to the LAN to provide to the portable computer data defining a page to be displayed on the portable computer, the page being arranged to require entry of a private “key” provided to the user of the portable computer only,
b) to receive the private “key” when entered,
c) to maintain a record correlating the key with the MAC-address of the portable computer,
d) to generate a billing record indicative of times of usage of the LAN by the portable computer identified by the recorded MAC-address.

19. Apparatus for connecting a portable computer to a LAN for which the portable computer is not configured comprising:
a LAN having a plurality of connection ports each for receiving connection to a portable computer for data communication between the LAN and the portable computer;
the LAN having a predetermined domain identifier for identification of computers connected to the LAN;
a communication computer;
the communication computer having a LAN connection connected to the LAN for communication of data between the LAN and the communication computer;
the communication computer being programmed to be responsive to messages using the predetermined domain identifier to receive a data transmission transmitted from a respective one of a plurality of computers connected to the LAN;
the communication computer being further programmed:
a) to be responsive to a web page request message using a domain identifier different from the predetermined domain identifier from a portable computer alien to the LAN to provide to the portable the requested web page when obtained and to add to the web page so provided an “in-house” start web page specified by the service provider and - generated or retrieved by the communication computer.
